(19) United States
(12) Patent Application Publication
(10) Pub. No.: US 2013/0304537 A1
(43) Pub. Date: Nov. 14, 2013

(54) System and Method for Access to, Management of, and Display of Property Data

(71) Applicants: Frederick J. Johnston, Chicago, IL (US); Raphael Morozov, Chicago, IL (US)

(72) Inventors: Frederick J. Johnston, Chicago, IL (US); Raphael Morozov, Chicago, IL (US)

(73) Assignee: CREwizard, LLC, Chicago, IL (US)

(21) Appl. No.: 13/470,876

(22) Filed: May 14, 2012

(51) Int. Cl. G06Q 30/02; G06F 17/00

(52) U.S. Cl. 705/7.29; 715/227

(57) ABSTRACT

A system and method for analyzing property data includes accepting links from a plurality of property files and to at least one library on a data storage device. Each property file has data identifying a property. Thereafter, the system receives at least one set of assumptions of property data for storage at the at least one library. The system also permits the at least one set of assumptions to be selected for use with a plurality of the property files linked to the at least one library.

### BACKGROUND

1. Field of the Invention

The subject matter herein relates to the analysis of property data and, in particular, to a method and system that permits access to, management of, and display of property data used for the analysis and forecasting of financial, occupancy, and other values commonly used in real estate.

2. Description of the Related Art

Conventional property data analysis computer programs accept inputs on a property by property basis. For example, the known programs can be used to calculate the current and expected cash flow, occupancy, and other values for a property, such as a building or other real property which includes one or more leased spaces (referred to herein as the “leases”). Common characteristics such as inflation, rent, tenant improvements (amounts paid to renovate suites in the property), and leasing commissions (amounts paid to brokers for obtaining tenants) can be entered in a property-level database. A user can then access these common property data in the database by or through multiple parts of the property file. In other words, rather than inputting rent data for each lease, a user may input common rent data in the property level database, and then point or link multiple leases to the rent data. These leases are then calculated using the common rent data. Users with multiple properties are forced to update each property file (also referred to as a property) individually so that the user may be inputting the same data for multiple properties and in multiple places which is cumbersome, error prone, and time consuming.

Further, referring to FIG. 1, these common data within three property files 1000, 1002, and 1004 are represented by simplified tables to explain the terms used herein. Each table 1006, 1008 1010, 1012, 1014, and 1016 represents a separate set of data contained within one of the property files 1000, 1002, 1004 to which lease inputs and other inputs 1018 within the same property file may be pointed to in lieu of directly entering data. In the illustrated example, elements, which are general categories, are represented by each table. In this instance, both rent and leasing commissions are elements. Each element may further consist of one or more sub-elements, such as the sub-elements low-rise and high-rise for the rent element. Each sub-element further consists of assumptions, which are the detailed data that comprise values contained in the sub-element.

For example, rather than enter a rent of $18 for a specific lease starting in year 3 at property file 1a, a user may point the lease to the low-rise sub-element within table 1000. This is useful when multiple leases are expected to have the same value for year 3. Property 1 has two files (file 1a and file 1b) for two different sensitivities (multiple versions of the data within a library) the property file has been duplicated, and all data remains the same except for assumptions entered for the sub-elements. In this example, the assumptions in table 1010 have been changed in the duplicate file to facilitate a comparison of outcomes based on the different inputs. Thus, the pairings of tables 1006 and 1008 (property file 1a), and 1010 and 1012 (property file 1b) represent separately stored data for property 1 where each property file has at least some duplicated base data.

When property files with user-defined scenarios contain identical data listing the same sub-element, the sub-element is frequently labeled differently between properties. For example, a user may label a rent scenario “Floors 1-12” at one property, and “Low-Rise Floors” at another property. This inconsistency in labeling makes it very difficult to perform comparisons between different properties when the comparisons require that some of the assumptions about financial parameters be the same for all of the properties being compared. This can be clearly seen in FIG. 1. Property 1a and Property 2 have identical assumptions, but the sub-elements within the rent element are labeled differently. In some instances, this will require duplicate data entry, which is time consuming and error prone.

Within a single property file, some known programs have system-defined elements which accept assumptions directly, and do not allow sub-elements. Examples of such elements in known programs include elements used to value the property, and elements used to calculate debt payments. For example, a user may be able to enter an assumption about the value of the property for every month the property is analyzed, but the user is restricted to only entering one set of assumptions for an element within each property file.

Within the known programs, there is a limited ability to sensitize the inputs. Typically, the sensitivity takes the form of allowing the user to enter a range of adjustments to a system defined element such as property value, and then run calculations using the adjusted variables. For example, a sensitivity feature may allow the user to calculate the value of a property if the assumption entered is increased by 5%-10% in 1% increments. The user could then view the property value based on calculations with a 5% increase, a 6% increase, etc. The sensitivity calculations for each element are independent, so, while it may be possible to calculate sensitivities for multiple elements, each sensitivity added expands the number of calculations significantly. In the example above, there would be seven valuation calculations (the baseline and adjustments of 5%-10% in 1% increments). If the user then added an identical sensitivity to the debt assumptions, creating seven independent debt calculations, there would be forty nine separate results for each period. Combine this with the fact that some variables change periodically (monthly, quarterly, or annually, for example), requiring a different set of calculations for each period, and a multi-variable sensitivity analysis quickly becomes cumbersome and of little use to the user.

Additionally, some elements require one or more user-defined sub-elements. For example, the element “rent” does not have any stand-alone data stored at the element level. The rent element cannot, by itself, be used for calculations. Rather, the user must add sub-elements that are then used for calculations. For example, a user could create multiple user defined rent sub-elements within a property (for example, low-rise rent, mid-rise rent, high-rise rent, ground floor retail rent, and storage rent). However, because of the complexity and variability inherent in user defined sub-elements, known programs do not have any system for allowing sensitivities (i.e. storing multiple versions of the data that make up a sub-element) within a single property file.

It is often necessary to analyze property and lease cash flows (or other values) using multiple sensitivities. With current programs, as shown above with FIG. 1, in order to sensitize the inputs associated with user defined sub-elements, it is necessary to duplicate the property file for each desired sensitivity, with, for example, an initial file and a duplicated file. In FIG. 1, property file 1a contains one set of assumptions, and property file 1b contains a separate set of assumptions for the same sub-element. In the illustrated example, low-rise rent for year 2 is $17 in the property 1a file, and the corresponding assumption is $19 in the property 1b file. In order to compare the outputs generated by these different assumptions, this file has been duplicated (including hundreds or thousands of other data entries in the database) In order to make additional comparisons, the user would need to duplicate the property file, open it, and change assumptions as necessary. The user could then generate calculations from each file, and compare the resulting outputs. This creates a lot of duplicate data, which wastes space on storage media, and is difficult to keep organized. It is not unusual to have over ten sensitivities when valuing a property for purchase.

An additional, and frustrating, problem arises when a change must be made to each property file. Specifically, it is common to discover data entry errors when valuing properties. For example, the area occupied under a lease may be 14,204 square feet, but a user mistakenly entered it as 41,204 square feet. When an error is discovered, or if another change needs to be made, it must be made to each property individually. If a user does not make the change consistently in all of the duplicate files, when the results of each file are compared, they may be impacted by both the data entered for the intended sensitivity scenario, and data that have been improperly updated. This may result in large errors. For example, if the user in the example above creates two separate files and believes the only difference between the two is that in one, the user estimates that rents will grow to be $19 in year 2, and in the other, the user estimates that rents will grow to a more modest $17. Though the user expects rents will grow to $19, the user may still be comfortable purchasing the property because, based on the calculations, even if rents only grow to $17, the user will still have sufficient cash flow to cover debt payments. In this case, the user expects some variance in the initial analysis between the two files because of the different rent assumptions, so there is no initial surprise—the mistake is still hidden. However, if, after purchasing the property, the user discovers that the lease error (14,204 square feet versus 41,204 square feet) was only updated in the file with the $19 rent, now it is understood that the variance was dramatically understated since the file with $17 rent is still calculating the lease with 41,204 square feet, and it is overstating contractual rental income by a significant margin, which masks the full impact of the rent sensitivity calculation. In other words, while the user thought she was comparing cash flows based on a change in a single variable in a single user defined sub-element (rent), the incorrect lease data offset the impact of the reduced rent, and led the user to believe the impact of the variable change would be significantly less than it actually was. Errors such as these can cause the user to overpay for the property or to have significant cash flow shortfalls.

In addition to the deficiencies mentioned above regarding analysis of multiple properties or within analysis of a single property, known programs also present even more complicated deficiencies when inputs need to be sensitized for an entire portfolio. When this is required, the issues mentioned above are combined. For example, in many cases, if a user is valuing a portfolio with one hundred properties, and each property requires ten sensitivities to sub-elements, the user must create one thousand files (ten sensitivity files for each of the one hundred properties). If a user needs to change a key metric that impacts all files, each of the 1,000 property files must be opened and updated in an extremely cumbersome and time consuming manner.

Some known programs provide sensitivity features for user defined sub-elements across multiple properties, but these have the same issues as mentioned above. The sensitivity features are simply a user interface that allows the user to view data from multiple property files in a single location. For example, to change a key assumption, some known programs use a table with the properties along one side of the table, and key assumptions along the other side of the table. For instance, in order to change rent growth for a Property X, the user finds Property X along the top of the table and then finds the metric “rent growth” along the side of the table. The user then updates the data for the specific property in the square where the indicated row and column intersect. Thus, for these known programs, sensitivity is a user interface where a user can view and edit data from multiple, independent property files all in one place. However, since the property files are still modified independently, no restrictions exist to ensure that the user or users describe the user defined sub-elements consistently. Thus, as mentioned above for separate property files, here too a rent sub-element may be labeled ‘Flrs 1-13’ in one property but ‘Low Rise 1-13’ at another property when they mean the same thing. Such inconsistent data entry for what is effectively the same sub-element throughout the property files requires repeat data entry and may substantially limit the ability to reliably perform calculations using multiple properties.

Some current systems have the ability to store multiple properties in the same database. However, for all practical purposes, the properties are handled as independent files. Data that are common between multiple properties are stored independently at each property, and there is no known ability to unify common data in a single location. For example, it is not possible to establish a rent sub-element for low-rise floors within office buildings located in Dallas, and have multiple properties reference the data. Rather, the data is stored with each property individually and an update to one property does not impact the others.

Some existing programs have the concept of a forecast that takes over after a contractual space expires (an existing tenant lease ends). For example, if a user enters a lease into the program that expires at the end of March 2014, and it is unknown what the existing tenant will do at its lease expiration, the user may also create a forecast that calculates hypothetical leases after the existing tenant's lease expires. Typically these hypothetical leases continue perpetually. For example, a hypothetical lease may start in 2015 and expire in 2020, at which point another hypothetical lease will take over. This creates a way to estimate cash flows, occupancy, and other values when future leasing is unknown. These programs, however, do not have the ability to automatically make changes in space usage. For example, if a 2,000 square foot lease expires, the forecast automatically creates hypothetical leases that are exactly 2,000 square feet. Further, these programs do not have the ability to track the use of space over time. For example, if a floor in a building is 10,000 square feet, a user may enter multiple leases at different points in time (and only assign forecasts to the last known leases). Then, if a 4,000 square foot lease expires, and a user enters a new lease for 3,000 square feet to take over after the expiration of the prior lease, it is unclear what part of the original 10,000 square feet, and in turn what part of the 4,000 square foot lease, is claimed.

Conventional programs also may provide the ability to apply filters to view the resulting cash flow, occupancy, or other values, from a group of leases with a common characteristic. For instance, known programs provide the ability to run reports such as “show contractual leases only” or “show office leases only” to calculate financial results for the indicated group of leases for a property. These systems, however, require that the lease start and end dates remain the same regardless of the filter state. More specifically, current programs allow you to enter contractual (existing) leases, and also allow you to enter future, speculative leases, but the dates are fixed based on user inputs. For example, if you have a large tenant in a building and that tenant has an option to renew at below market rates in January 2018, in order to calculate the two most likely scenarios, you have to create two separate property files: (1) tenant exercises option (which contains a hardcoded lease that starts in January 2018), and (2) tenant does not exercise option, where the tenant vacates at the end of its current lease term, and new leases (either hardcoded, or forecast) are then added. Thus, the known programs do not permit the user to shift the timing of hardcoded leases, and forecast leases. Rather, a user must create a duplicate property file, and hardcode different assumptions for the leases in question, and then compare the resulting outputs.

### SUMMARY OF THE INVENTION

The deficiencies mentioned above are solved by the present system for analyzing property data. The present system comprises at least one library with at least one set of assumptions of property data and stored on a data storage device. The at least one library is configured to accept links from a plurality of property files. Each property file has data identifying a property. A system component is configured to permit the at least one set of assumptions to be selected for use with a plurality of the property files linked to the at least one library.

In another aspect, the system has a library with sets of assumptions of property data stored on a data storage device. The library is configured to accept links from one or more property files identifying a property, while the library data has a baseline layer has a set of assumptions of property data. At least one sensitivity layer at the library has a set of assumptions of property data with at least one of the assumptions different from an assumption on other layers within the same library. A system component is provided to generate a user interface permitting a user to select at least one of the layers for use with a property file linked to the library in a financial calculation.

In yet another aspect, the system has a system component for receiving lease data input by a user for a section of property to perform a calculation including data from multiple leases of area in the section. At least one lease is a removable lease from the calculation, and the data for each lease includes at least a lease start date, a lease stop date, and the amount of area leased. The area leased consists of claims on area in the section of the property, other leases of area in the section, or a combination of both. A filter is provided for removing the at least one removable lease from the calculation, and the system automatically modifies lease data to fill a gap in time and lease space in the section and created by omitting the removable lease.

To provide a way to display leases in a calculation, a system for displaying property data is provided and has a chart component to generate a chart for presenting building lease information on a user display. The chart has a lease space axis representing an area of a lease, and a time axis extending transverse to the lease space axis. Indicia on the chart represent an existing lease or a future lease, where each indicia is placed on the chart to represent lease parameters comprising a lease start date, a lease end date, and the amount of area leased. A removable lease may also be provided.

A method for analyzing property data is also providing to resolve the deficiencies mentioned above. The method includes accepting links from a plurality of property files and to at least one library on a data storage device, where each property file has data identifying a property. Also, receiving at least one set of assumptions of property data for storage at the at least one library, and permitting the at least one set of assumptions to be selected for use with a plurality of the property files linked to the at least one library.

Other methods include accepting a link from a property file having data identifying a property to a library stored on a data storage device, and forming a baseline layer with a set of assumptions of property data at the library. Then, the method includes forming at least one sensitivity layer with a set of assumptions of property data at the library where the set of assumptions of the at least one sensitivity layer has at least one different assumption from an assumption on other layers within the library. This method then includes permitting selection of at least one of the layers for use with the property file in a calculation.

Yet other methods include receiving lease data input by a user for a section of property to perform a calculation including data from multiple leases of area in the section. Also here in this method is including, in the data for each lease, at least a lease start date, a lease stop date, and the amount of area leased, where the area leased includes claims on area in the section of the property, other leases of area in the section, or a combination of both. The method further includes providing at least one lease as a removable lease from the calculation, and filtering the at least one removable lease out of the calculation. Then, the method includes automatically modifying lease data to fill a gap in time and lease space in the section and created by omitting the removable lease.

A method for displaying property data is also provided and includes generating a chart for presenting building lease information for a user display. The chart has a lease space axis representing an area of a lease, a time axis extending transverse to the lease space axis, and indicia on the chart representing an existing lease, a removable lease, or a future lease. The method also includes placing indicia on the chart to represent lease parameters with a lease start date, a lease end date, and the amount of area leased.

Another method for analyzing property data includes receiving lease data for a plurality of leases including at least one pipeline lease that is in negotiations with a potential tenant. The data for each lease includes at least a lease start date, a lease stop date, and the amount of area leased. The method here is using the lease data in a property analysis calculation, and automatically removing or inserting pipeline lease data into and out of the calculation to change the calculation results when instructed to do so by a user.

### BRIEF DESCRIPTION OF THE DRAWINGS

FIG. 1 is six simplified tables for explaining elements, sub-elements, and a sensitivity as understood in the prior art;

FIG. 2 is a schematic diagram of a communications network including a system for access, management, and display of property data for financial analysis and forecasting;

FIG. 3 is a schematic diagram of the system for access, management, and display of property data for financial analysis and forecasting;

FIG. 4 is a schematic diagram of the modules and managers used by the system of FIG. 3;

FIG. 5 is a schematic diagram showing a network used by the system of FIG. 3;

FIG. 6 is a flow chart depicting one possibility for the general operation of the system of FIG. 3

FIG. 7 is a schematic diagram of a property file and related functions used by the system of FIG. 3;

FIG. 8 is a section data interface for use with the system of FIG. 3;

FIG. 9 is a suite/lease data interface for use with the system of FIG. 3;

FIG. 10 is a flow chart for a share library routine for the system of FIG. 3;

FIG. 11 is a library function interface for the system of FIG. 3;

FIG. 12 is a flow chart for a link property to shared library routine for the system of FIG. 3;

FIG. 13 is a link to a library interface for the system of FIG. 3;

FIG. 14 is a flow chart for an unlink from a shared library routine for the system of FIG. 3;

FIG. 15 is a library interface for the system of FIG. 3;

FIG. 16 is a sub-element interface for the system of FIG. 3;

FIG. 17 is a sensitivity layer interface for the system of FIG. 3;

FIG. 18 is a flow chart for a create a sensitivity layer routine for the system of FIG. 3;

FIG. 19 is a flow chart for an activate a sensitivity layer for the system of FIG. 3;

FIG. 20 is a workgroup interface for the system of FIG. 3;

FIG. 21 is a share property interface for the system of FIG. 3;

FIGS. 22-23 are flow charts for a share properties with workgroup routine for the system of FIG. 3;

FIGS. 24-25 are flow charts for a remove properties from workgroup routine for the system of FIG. 3;

FIG. 26 is a portfolio interface for the system of FIG. 3;

FIG. 27 is a schematic diagram of a network showing shared portfolios for the system of FIG. 3;

FIG. 28 is a pipeline interface for the system of FIG. 3;

FIG. 29 is a forecast interface for the system of FIG. 3;

FIG. 30 is a diagram of a space continuity chart for the system of FIG. 3;

FIG. 31 is another diagram of a space continuity chart for the system of FIG. 3;

FIG. 32 is another diagram of a space continuity chart for the system of FIG. 3; and

FIG. 33 is another diagram of a space continuity chart for the system of FIG. 3.

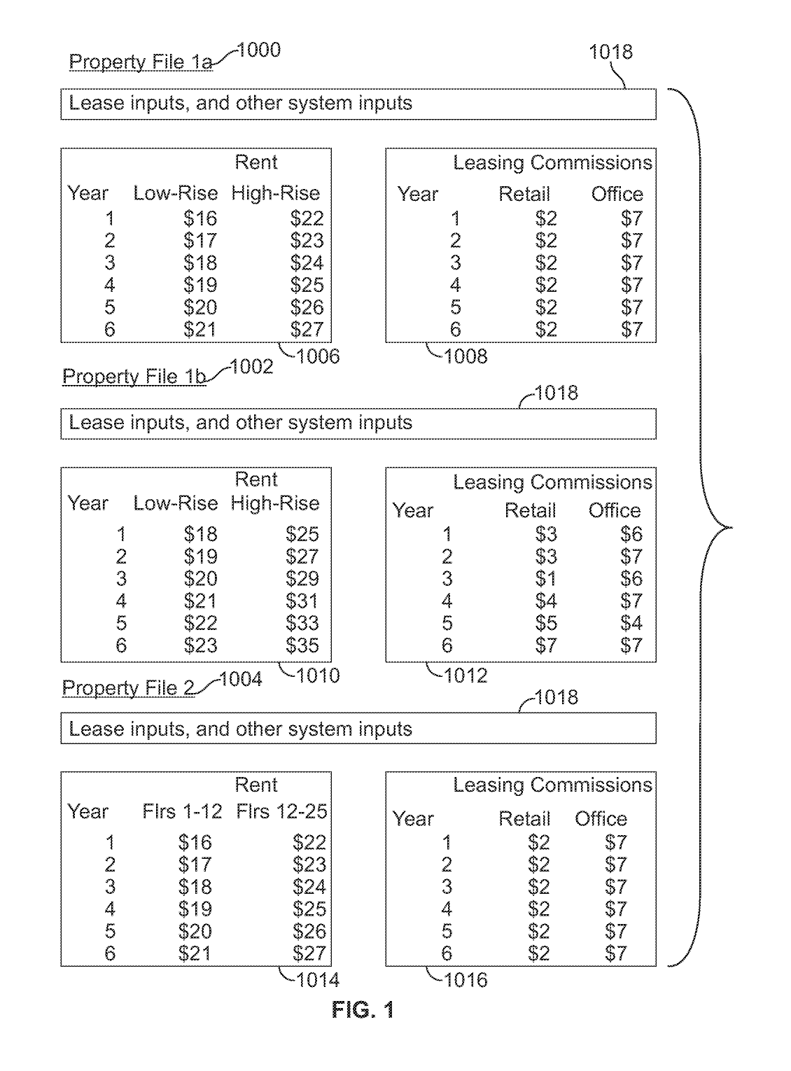

### DETAILED DESCRIPTION OF THE PREFERRED EMBODIMENTS

### I. General Aspects of the System

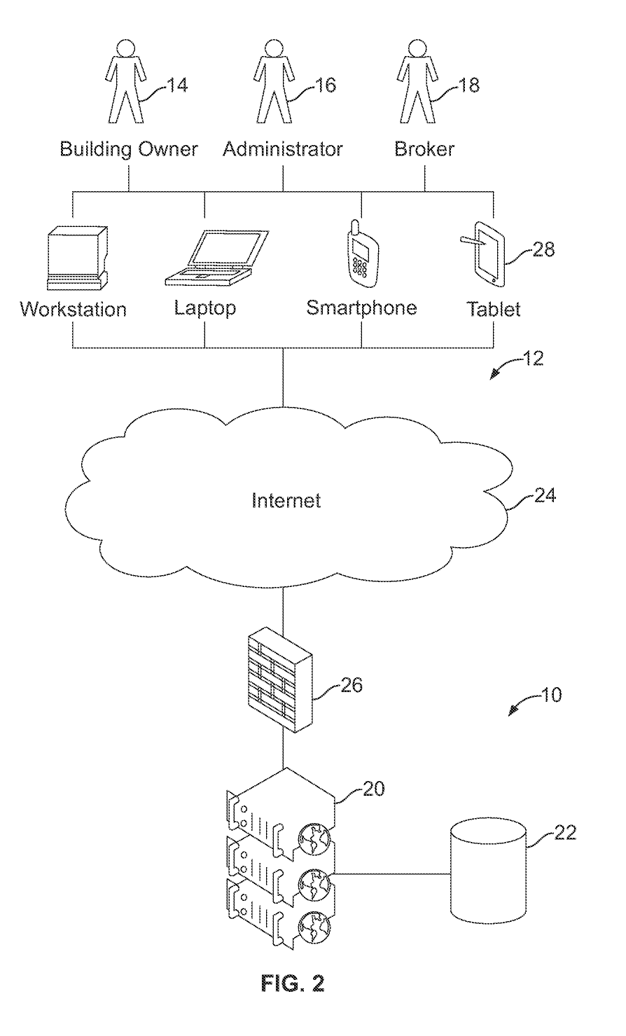

Referring to FIGS. 2-4, a system 10 for financial analysis of property data described herein is an improvement over known systems in a number of different ways. The system 10 applies to a property such as real property like a building, land, and so forth that is divisible into one or more leasable spaces or units (also referred to herein as lease spaces or simply leases). The system 10 is used to generate calculations based on leases and other data in order to analyze the current and expected performance of a property and make financial predictions regarding the property. To accomplish this, the system 10 uses libraries that store data that can be common to multiple inputs within a property file and multiple properties.

System 10 is based on a network that allows links by a number of property files to a single property data library so that that each property file (also referred to herein simply as a property) can share the data at the library and among the property files so that a user need only enter data once. The data, such as a set of assumptions described below, can then be automatically accessed by the other property files rather than requiring a user to enter the same data into each property file separately which saves time. This also completely eliminates the possibility of inconsistent labeling for the same category of data on different property files.

The library may also hold data in multiple layers in order to form different sensitivities. The library has a base layer providing a number of different library elements which are system defined. These library elements are categories such as rent, tenant improvements, and leasing commissions which may accept sub-elements which are user defined. For example, sub-elements of a rent element may include low-rise rent and high-rise rent. The actual user-defined values entered within these elements and sub-elements are referred to herein as assumptions. For example, the annual rent values that may be entered in the low-rise rent sub-element are referred to as assumptions. These elements, sub-elements, and assumptions are initially defined in the library's baseline layer. Users may then form sensitivity layers. A sensitivity layer is formed by creating a new layer within a library which allows different assumptions to be entered for that layer. While duplicate layers may be maintained when desired, in one form, each sensitivity layer has at least one different assumption than that in the other, or all, sensitivity layers and/or the baseline layer. There is no application-generated limit as to how many sensitivity layers may be formed, and the layers may be used independently of each other. Such a configuration provides a great advantage by enabling a user to customize a sensitivity layer with ease, and apply it to any number of property files without the need to have a separate, duplicate property file for each sensitivity. This system conveniently and efficiently limits the need to duplicate data entry and limits unintended results from a mistaken entry. Further, it allows the creation of sensitivity layers that combine the impact of multiple factors into one cohesive set of assumptions. For example, when rents drop, tenant improvements often increase (to induce tenants to move from one building to another), and the system allows the changes to these assumptions to take place in unison. Links that are made to the one or more layers within a library are referred to as library linking, linked libraries, library links, joining a shared library, or simply a link to a library.

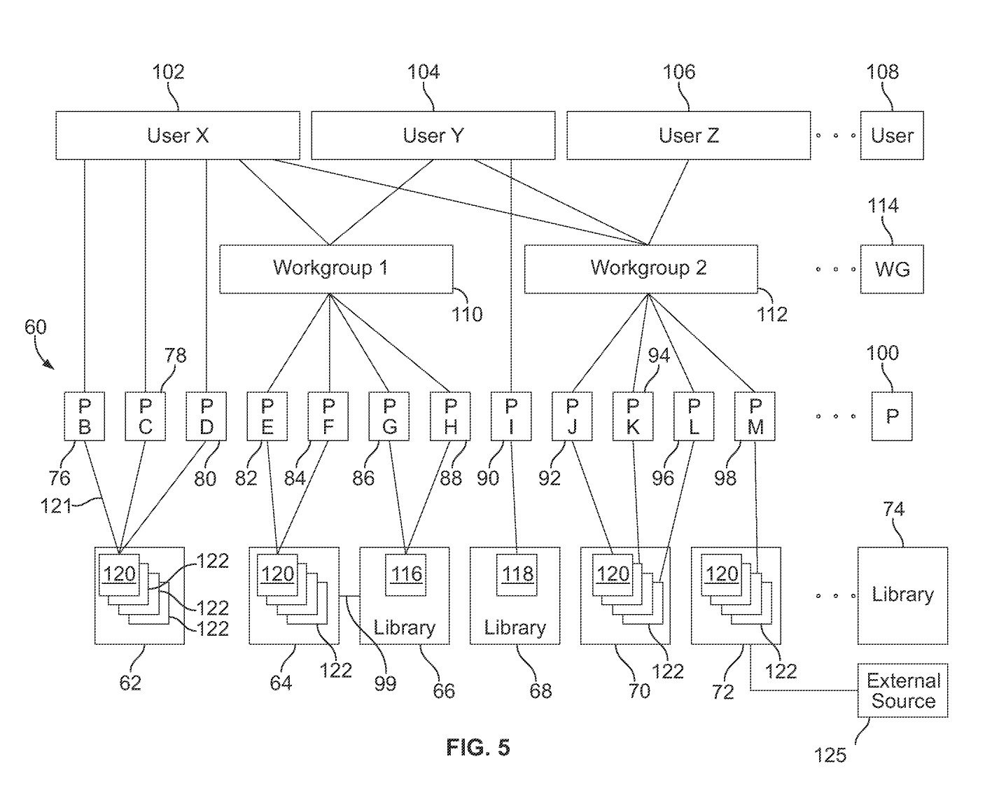

The example network (FIG. 5) used by the system 10 also carefully controls which users may be allowed into, or barred from, the system. The system 10 permits membership into workgroups. Workgroups consist of a set of users which have access to a set of property files and the libraries those properties are associated with. For example, a workgroup may consist of users from the same company. If a need arises to share a sub-set of properties with a third-party such as a potential buyer, a new workgroup may be created which consists of the sub-set of properties, the users from the company, and the users from the potential buyer. Thus, members of the company will be able to access both the properties in their company workgroup, as well as the sub-set of properties in the workgroup that is shared with the potential buyer, while the potential buyer will only have access to the properties in the workgroup containing the sub-set of properties which they are considering purchasing. The users within a workgroup are able to access each other's property files and library layers (baseline and sensitivity layers). Each property file is linked to a single library. An authorized user may unlink a property file (or property files) from its current library and then link it to a new or existing library. This configuration provides a tremendous advantage in organizing the network while permitting the users many options for linking a property file to a specific set of commonly used data (the library)

Another aspect of system 10 is that the system 10 conveniently provides the ability to toggle some of the leases in and out of calculations such as cash flow. Specifically, the system 10 may have a property manager or other program component for receiving lease data input by a user (or uploaded from another source) and provides lease data for a property for existing (including historical) leases and removable leases, such as future leases and options. The data for each lease includes at least a lease start date, a lease stop date, and the amount of area leased. Each lease may also include additional information about the type (new, renew, expansion, option, and others, for example) and/or status (contractual, in negotiation, pending, and others, for example) of the lease. A calculation may then be performed using data from multiple or all entered leases in a property data analysis calculation. A filter may be used to remove at least one lease from the calculation based on a variety of parameters such as, for example, the amount of area leased, the start rent, the type, the status. There are many possibilities for filters that may be applied. In this case, the property manager and forecast manager, if authorized by the user, automatically modifies subsequent lease data to fill a gap in time and leased space created by omitting the lease excluded by the filter. A forecast manager automatically generates data for forecast leases that begin after the end of another lease.

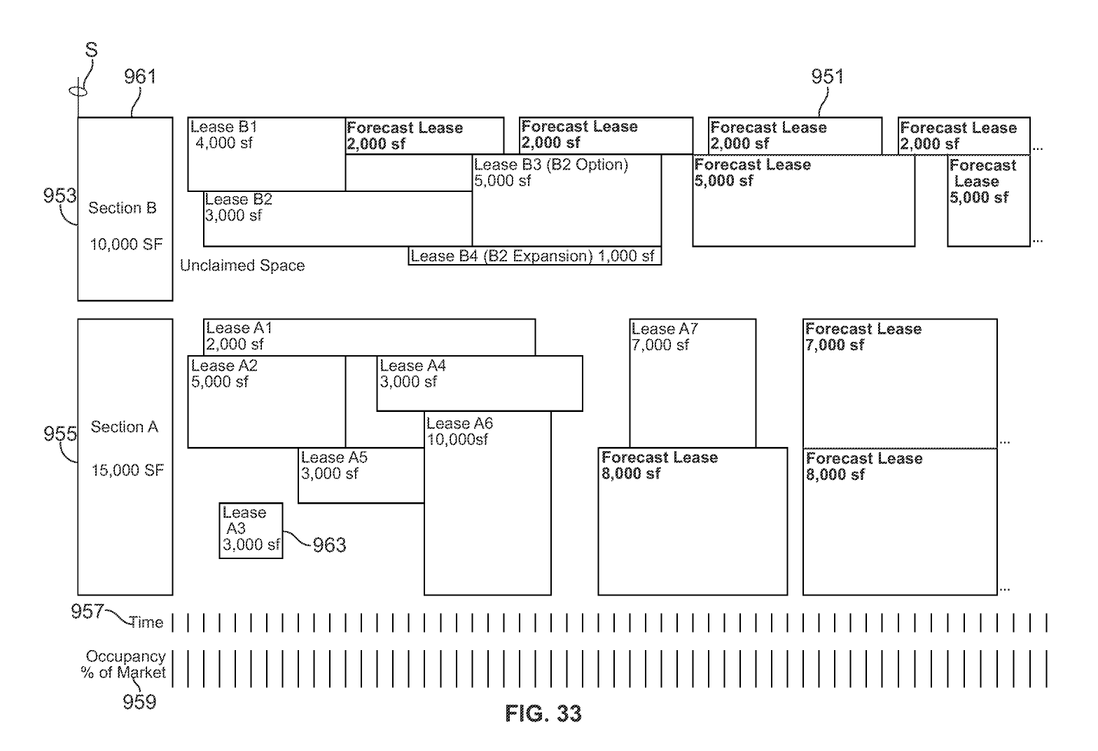

As can be understood from the display 951 (FIG. 33), system 10 also conveniently provides a chart or graph for a user's display to show the representation of leases within a section (a section typically represents a floor, but can represent other divisions of a building) for example and that are to be included in the property data calculations. The chart provides a very easy way to determine the duration and area of a lease relative to other leased areas, and presents the building lease information mentioned above. The chart has a leased space axis representing an area of a lease, a time axis extending transverse to the lease space axis, and indicia, such as a four sided figure, parallelogram, rectangular box, three-dimensional shapes such as a cube or any other shape on the chart representing each lease which is currently in use for calculations (based on the filters applied). Each lease or box represents the lease parameters of a lease start date, a lease end date, and the amount of area leased. Filtering a lease or group of leases in and out of the calculation also toggles the leases in and out of the display, and shows how the future leases shift position in time and space to fill the gap left by the removed lease. It should be understood, that in some instances, a full lease may not be fully removed by a filter, but rather shortened. For example, if a contractual (existing) lease is five years long and has an additional five year option period entered as part of the same lease record, a user may exclude the option period from the lease by applying the filter. In other words, in the case of option leases, the option period may either be entered as a separate lease record, or as part of the primary (before the option period) lease record. Applying a filter to remove options from calculations will remove both option periods in leases, and remove freestanding option leases.

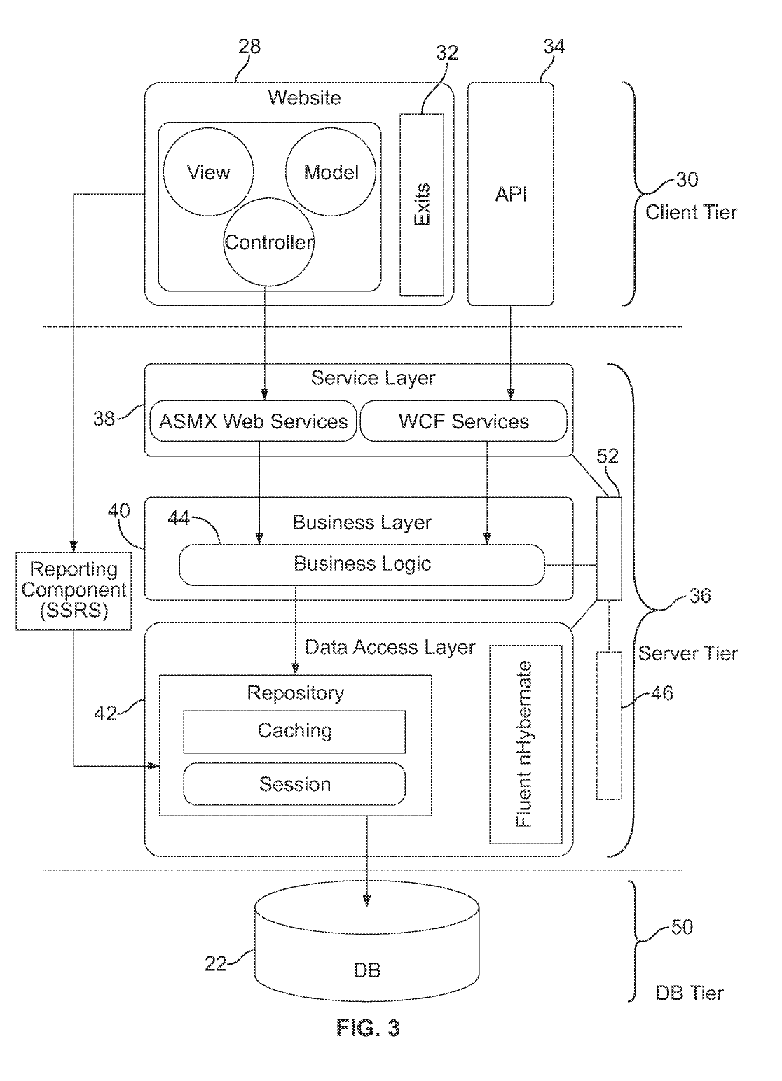

Referring to FIGS. 2-3, the system 10, in one form, may operate on a communications or computer network 12 that connects users 14, 16, 18, with a number of servers 20 and a database 22 through the internet 24, WAN, or LAN. A firewall 26 may be used to protect the system 10. Otherwise, the system 10 generally defines three tiers although other configurations are contemplated. On a client tier 30, users 14, 16, 18 may logon to the system 10 through a website 28 or other similar portal that is provided on any computer network device 28 such as a computer workstation, laptop, cellular phone, smart phone, tablet, and so forth, as long as the device has a display for conveying information to the user and sufficient memory for downloading the information. In one form, the website 28 is implemented using Microsoft ASP.NET MVC 3.0 framework. A client-side library 32 based on Ext.JS may also be provided for interaction with the system 10 and for managing AJAX interactions. The client tier 30 may also include an API (application programming interface) 34 for providing secure structured interaction between third-party applications and the business layer 40.

On the server tier 36, in one form, three main layers are provided: a service layer 38, a business layer 40, and a data access layer 42. The service layer 38 provides the communication link for the client tier 30. In one form, the service layer 38 is the only way to communicate between the client tier 30 and the business layer 40. The service layer 38 has a series of web services, such as ASMX for example, communicating with a controller 44 providing the website 28 on the client-side. Services, such as Restful WCF for example, are used to communicate with the API. However, other similar forms and/or versions are contemplated. Data transmitted through the service layer 38 is sent to, or received from, the business layer or business object layer 40.

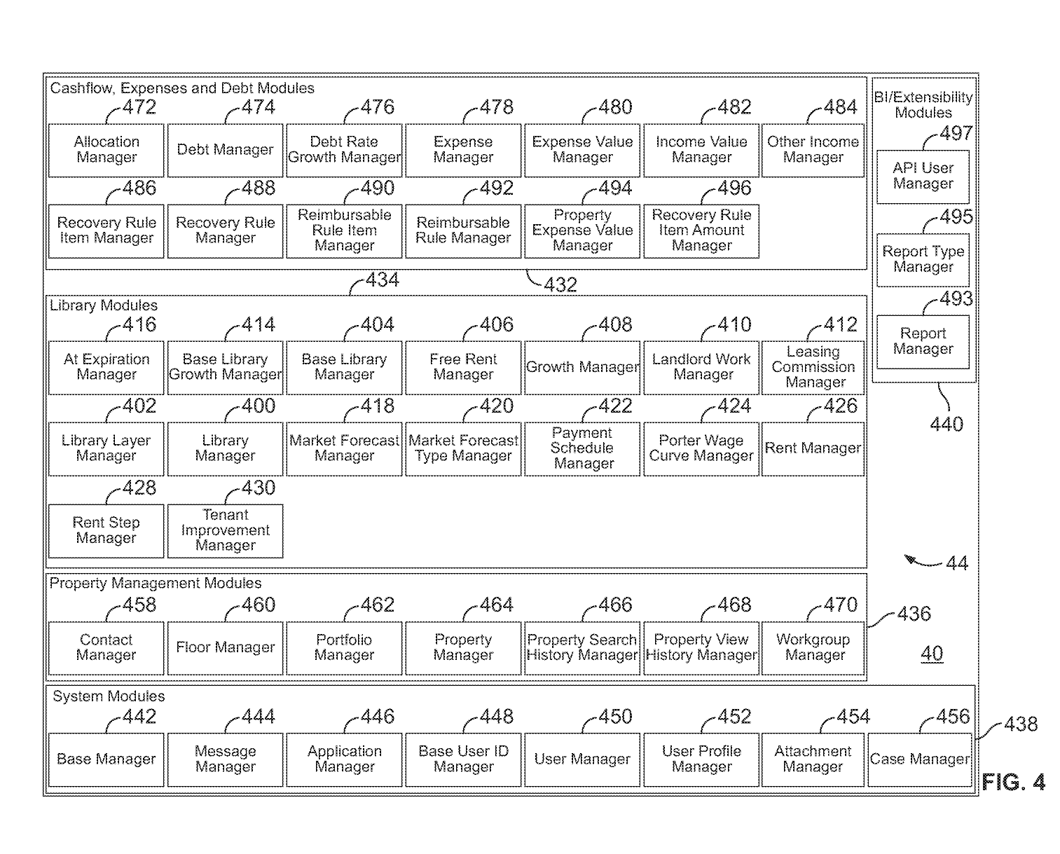

The business layer 40 forms the business logic or application 44 that operates the system 10, and more specifically, the modules or managers that form the application 44 (FIG. 4). The application 44 (including the actual program and its modules) are stored on a storage device 46 such as a memory on the servers 36. It will be understood the location for the storage of the application is not limited to a particular place and may be provided on a separate cloud server over the internet or other network, and/or at a location separate from the database 22. One or more processors 52 are also provided on the system 10 to operate the business logic 44. The application is a Microsoft.Net web application written using .Net framework 4.0 or other versions.

In one form, the data access layer 42 is implemented using Fluent nHybernate ORM (Object Relational Mapping) with direct entity-to-table mapping. The data access layer 42 has a repository 54 with a cache 56 for application data and a session 58 for user-dependent data to hold and organize incoming or outgoing data from the database 22.

On the database tier 50, the database 22, in one form, is hosted by Microsoft Sql Windows Server 2008 R2 using IIS 7.5 with Sql Server reporting services as the reporting platform. Other similar hosts and/or versions are contemplated.

Referring to FIG. 4, the application 44 has a group 432 of cash flow, expense, and debt modules or managers 472-496 for property level financial analysis of the property data, a group 434 of library modules or managers 400-430 for managing the libraries, the layers on the libraries, and the data for each property related element, category or parameter that is analyzed by the application. The application 44 also has a group 436 of property management modules or managers 458-470 to manage the property file intake and identification for example, a group 438 of system modules or managers 442-456, and a group 440 of BI/extensibility modules or managers 493, 495, 497 for orchestration of structured and ad-hoc access to application data. Each manager is appropriately titled to relate to the tasks managed by that manager (for example, the library layer manager manages the creation, modification, and access to the baseline and sensitivity layers on the libraries). It will also be understood that the use of the term manager or module alone, herein, does not limit such manager or module to a separate or distinct part of a computer program or to the programming or performance of any particular tasks but merely means a computer, application, or program component that controls the indicated tasks in the system 10.

Referring to FIG. 5, the system 10 may be implemented in a number of different forms as exemplified by data flow or interaction network 60. Network 60 shows a number of possible different configurations for linking together one or more libraries 62-74, property files 76-100, users 102-108, and workgroups 110-114 for the present system 10.

Generally, a library 62-74 is a central place to enter property data that is used multiple times throughout the system 10 to limit the need for repetitive entry of data. For example, rather than directly inputting data for a leasing commission for each lease, the user can elect to enter the data once into library 62. This may be performed through any of properties 76, 78, and 80 or can be accessed directly. Then, the user may point other property level inputs (such as those associated with leases) from the same property file or other property files 78, 80 also linked to the library 62 to the same library data.

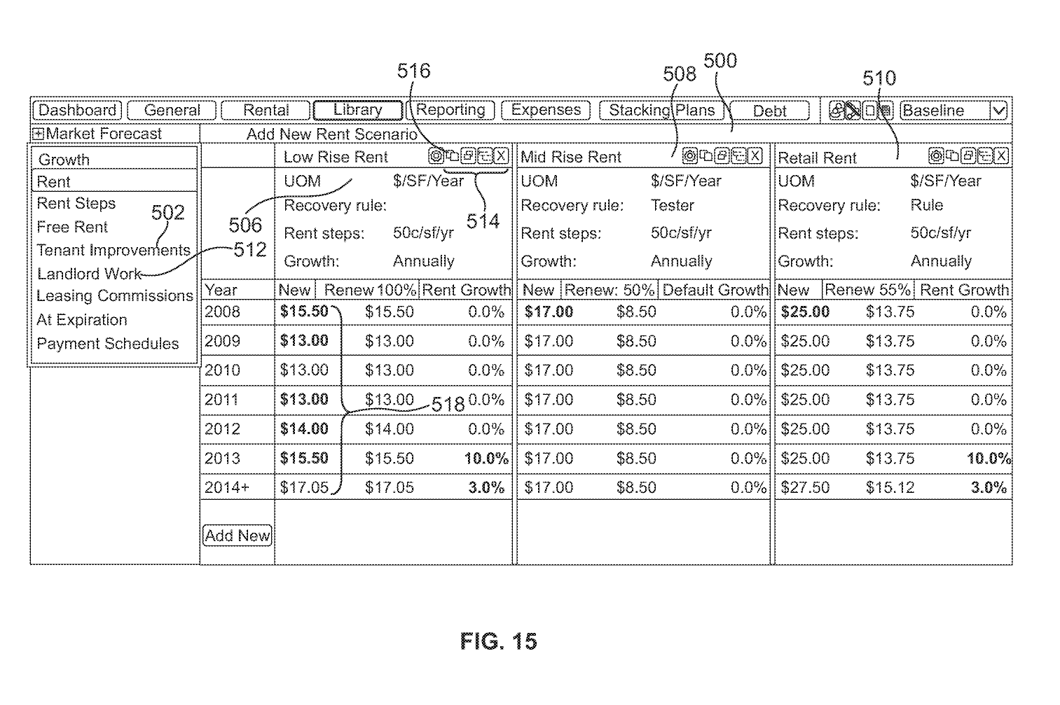

To accomplish this, each library 62-74, controlled by library manager 400 (FIG. 4), has one or more library layers controlled by a library layer manager 402. The library layers include at least one base or baseline layer 116, 118, 120 (also referred to as the baseline) managed by a baseline library manager 404 (FIG. 4). The baseline layer defines the default values for each separate library element (or main categories of property data). These elements may include, for example, rent, rent steps, tenant improvements, lease commission paid for obtaining tenants, free rent periods provided to tenants, landlord work, payment schedules, growth assumptions, next lease which contains assumptions about the probability of a tenant renewing its lease, valuation, and debt. These elements are provided as options to the user from a list on a user library interface 500 (FIG. 15) described in greater detail below. Each of these elements may have its own library module or manager 406-430. The library elements are defined by the program, are consistent across libraries, and may be updated by the system administrator so that there are a greater or lesser number of elements available in libraries throughout the system.

Each of the elements may also have sub-elements. For example, under rent, there may be sub-elements of storage rent, low rise rent, high rise rent, and retail rent, to name a few examples. These sub-elements may be user defined.

Each sub-element consists of a set of assumptions. For example, if a sub-element lists rents by the year such as a rent value for each of year 1, year 2, year 3, and so forth, each year accepts data(which may be directly entered, imported, or may be calculated by the system). Sub-elements may also accept data for a single time period, such as next month, and may also accept values for a different parameter than time. Sub-elements may also accept a combination of data. For example, a rent sub-element may accept periodic rent data, periodic rent growth data, rent step data (increases under an actual or projected lease), and multiple other data that collectively provide inputs for a rent calculation. Many other examples exist.

An example of three different rent sub-elements is shown on area 504 of FIG. 15. Thus, each library element can have multiple sub-elements so that each baseline layer 120 may have multiple elements, each of which may contain multiple sub-elements.

Users can also add sensitivity layers 122, which are variations on the baseline, such as “downside sensitivity” or “upside sensitivity.” A sensitivity layer 122 is used to sensitize (test different assumptions) for property inputs via library elements and sub-elements. Values can vary between each of the sensitivity layers 122 and the baseline layer 120. For example, a user may enter $10 as the 2014 rent in the baseline layer for “low-rise rent,” $8 in the “downside sensitivity” layer (poor economic outlook) for “low-rise rent” and $12 in the “upside sensitivity” layer (good economic outlook) for “low-rise rent.”

A sensitivity layer 122 is any library layer other than the baseline layer 120. The sensitivity layer 122 appears to the user as a duplicate of the baseline library layer 120, where different assumptions may be entered, imported, or calculated. An example of a sensitivity layer 526 with a sub-element input is shown as 530 in FIG. 17. This sensitivity layer 526 has multiple assumptions. Sensitivity layers make it possible to perform property calculations based on a different set of assumptions (sensitivities) for elements and sub-elements entered in the library. These layers can be toggled in and out of reports and displays so that the user can view the impact on cash flow, occupancy, and other key variables.

In one form, all sub-elements are defined in the baseline layer in order to maintain consistent naming of sub-elements, limit or eliminate the need to duplicate data entry, and to limit the probability of mistakes. In other forms, it may be possible to add new sub-elements to sensitivity layers first which are then copied directly to other sensitivity layers and/or to a base layer.

It should be appreciated that generally the set of data within a layer may not necessarily be limited to a single element or sub-element unless otherwise stated. Thus, a particular layer may provide a set of assumptions including some values for rent, some values for tenant improvements, and some values for leasing commissions, and this particular situation created by this set of assumptions may be desirable to apply to one or multiple properties linked to the library

Even though a sensitivity layer is saved at a library, a user may still need to instruct the library layer manager 402 to activate the sensitivity layer for inclusion in general calculations. The sensitivity layer 122 is then considered live. Using the same example above, if five properties link to a library, and users map “low-rise rent” to certain leases on lower floors at each of the properties, when the baseline is active, $10 will be applied to calculations which rely on the library. Similarly, if the downside is then activated, $8 will be used in the calculations, and if upside is then activated, $12 will be used for calculations. However, it is still possible to run comparison visualizations and reports without activating sensitivity. For example, a user can, at the same time, and in the same place, view different versions of cash flows, each calculated with a different sensitivity layer 122.A shared library 62, 66, 70, or 72 is a library that allows a number of property files to be linked to the layers in the library (FIG. 5). A library link 121 generally refers to the link between a property file 76-100 and a layer within a library 62-74 unless otherwise noted. When a library file is created, it may not initially be shared. A user with authorization to do so can convert an unshared library to a shared library at any point in time. Once a library is shared, other properties may be linked to layers within the library. Libraries are also a key gateway for external data. Through API 34, libraries 62-74 can be used to import/export data (including real time updates from external sources of market data). For example, a user can import data from third party data providers to update library data, including forecasts explained below. The forecasts can be used for calculations, comparisons, and so forth. External data providers can also be given authorization to access the system and download property data as well. This data may then, for example, be aggregated, to calculate expected rents for a given property type or market. An example of a library 72 with a connection to an outside system 125 is shown in FIG. 5.

Referring to FIG. 5, the network 60 also has libraries 66, 68 shown to have only a baseline layer 116 and 118, while libraries 62, 64, and 72 have sensitivity layers 122 built from the baseline layers 120. As explained above, each sensitivity layer 122 and each baseline layer 120 may have a different set of assumptions that can be used with a property file linked to the library to perform analysis for that property identified by the property file.

In one form, the user 102 has three properties 76, 78, 80 that are not included in a workgroup, but are linked directly to the library 62. Thus, the properties 76, 78, 80 are not shared properties, and can only be accessed by user 102. Also with this configuration, only user 102 can use library 62. With these links, the user 102 can select which of the layers among sensitivity layers 122 and baseline layer 120 to use with any of the property files 76, 78, and 80. The layers are shown here to link to the same baseline layer 120 (meaning the baseline layer is activated for use in calculations) although this need not always be the case as explained below.

In the illustrated example, in addition to the unshared properties 76, 78, 80, user 102 also has a membership in a workgroup 110 that contains properties 82, 84, 86, 88. The workgroup 110 provides access to multiple, and here two, libraries 64, 66, where two properties 82-84 or 86-88 are respectively linked to separate libraries 64, 66. In one form, if one property linked to a library is also part of a workgroup (also called sharing a property with a workgroup), then all of the properties linked to that library are shared with the workgroup as shown by workgroup 110. Also, there is no cross-over of library links between workgroups. Each workgroup has its own collection of property files and libraries. As explained in greater detail below, while properties and associated libraries can be fairly easily moved between workgroups, in one form, each property and each library can only be part of one workgroup at a time. However, a user may still have separate memberships in more than one workgroup. For example, user 104 has membership in both workgroups 110 and 112. In other forms, it may be possible for a each property and each library to be part of multiple workgroups.

Properties 82, 84 are also linked to a baseline layer 120 in library 64. Thus, a user may select any of the layers 120-122 in library 64 for calculations with the properties 82, 84. It is also possible to permit a user to select a layer to apply to a certain calculation within the property files 82, 84 (a single property may access multiple layers within a library). In contrast, properties 86, 88 are linked to a library 66 which has only one layer (the baseline layer 116).

In another aspect, the combination of user 104, property 90, and library 68 where library 68 only has a baseline layer 120 illustrates one of the simple, minimal configurations to generate data for the system. Here, the library 68, although configured to link to a plurality of property files, may only be linked to one property file 90 that has data identifying a property. The user 104, however, also may have access to a more complex configuration such as the two workgroups 110 and 112, which provides access to libraries 64, 66, 70, and 72, and properties 82, 84, 86, 88, 92, 94, 96, 98, forming access to a much larger property portfolio.

In yet another aspect, workgroup 112 provides users 102, 104, 106 access to properties 92, 94, 96, which are linked to a shared library 70. Each property 92, 94, 96 can have a separate active layer within the shared library 70. In this example, property 92 has the baseline layer 120 active, and properties 94 and 96 have separate sensitivity layers 122 active. The combination of property 98 and library 72 illustrates that it is also possible to select an active sensitivity layer in libraries which are not shared.

While the network 60 shows a number of possible example configurations, it will be understood that many other configurations with users, workgroups, properties, libraries and/or library layers exist, and no limit exists as to the number of these components that may be linked to each other than the limits of the communications network and computer equipment the system is provided upon (for example, memory space, bandwidth, and so forth).

In other alternatives, the system 10 may be configured very differently. For example, a separate library could be associated with each property (rather than shared libraries, each of which accepts links by one or more properties), and the libraries could be “linked” by a link 99 (shown in dashed line on FIG. 5 for example) so that each library 64, 66 updates whenever a change is made to any of them. In another aspect of the system 10, some property transactions such as sharing a library, linking to a library, and joining a workgroup are only available to a property administrator. Each property has a designated administrator (initially whoever created the property). Administrative privileges can be easily transferred between members of a workgroup. For example, user 102 could transfer administrative privileges for properties 82, 84 to user 104. In one form of the system 10, all properties linked to a library have the same administrator. Thus, the system 10, or specifically the library manager 400, transfers the administration rights for all properties referencing a shared library to a single property administrator. Property administration privileges are different than workgroup administration privileges (explained below) which allow the user to add/remove users in a workgroup and approve the inclusion of properties.

### II. General Method for Operating the System

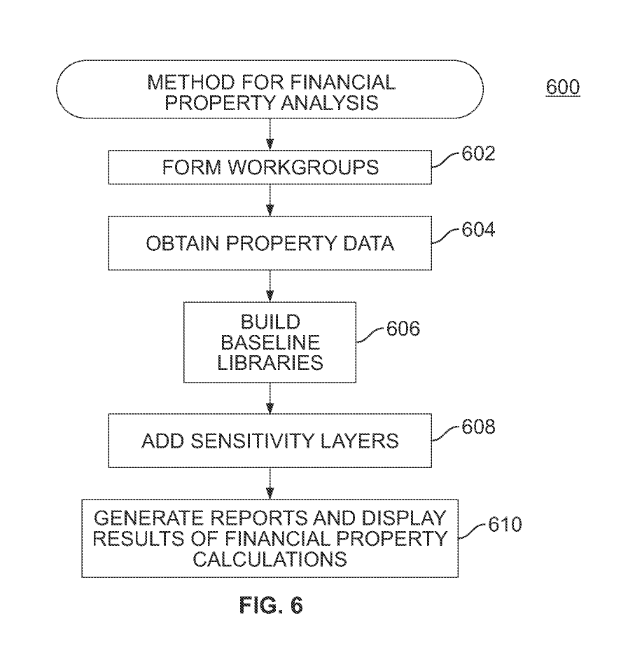

Referring to FIG. 6, the system 10 can be implemented in many different ways. One potential way is the method (600) that includes first forming workgroups (602) to provide a group of users access to the to-be-created property and library files, and next creating property files and obtaining (604) property data including information about the properties and their leases and other data being analyzed. This also includes linking at least one property file, or a plurality of property files, to at least one library (which may be done automatically by the system by creating a new library file upon the creation of a property file), where each property file at least identifies a property. In one form, a property can only be linked to a single library. Then the baseline of the library is built (606) which may include receiving at least one set of assumptions of financial property data for storage at the library, and this may be in the form of sub-element data. Sensitivity layers may then be added (608), and reports or displays of the results of the financial calculations may be generated (610). The process for operating the system 10 is provided in greater detail below. This is just one method of many that may be utilized to implement the system 10. For example, a user may create property files before creating and adding users to a workgroup or a user may choose to link a new property file to an existing library rather than build a new library with baseline and sensitivity layers. Thus, it will be appreciated that there are many different ways to order the steps 602-610, and all possibilities are included herein.

### III. Property File

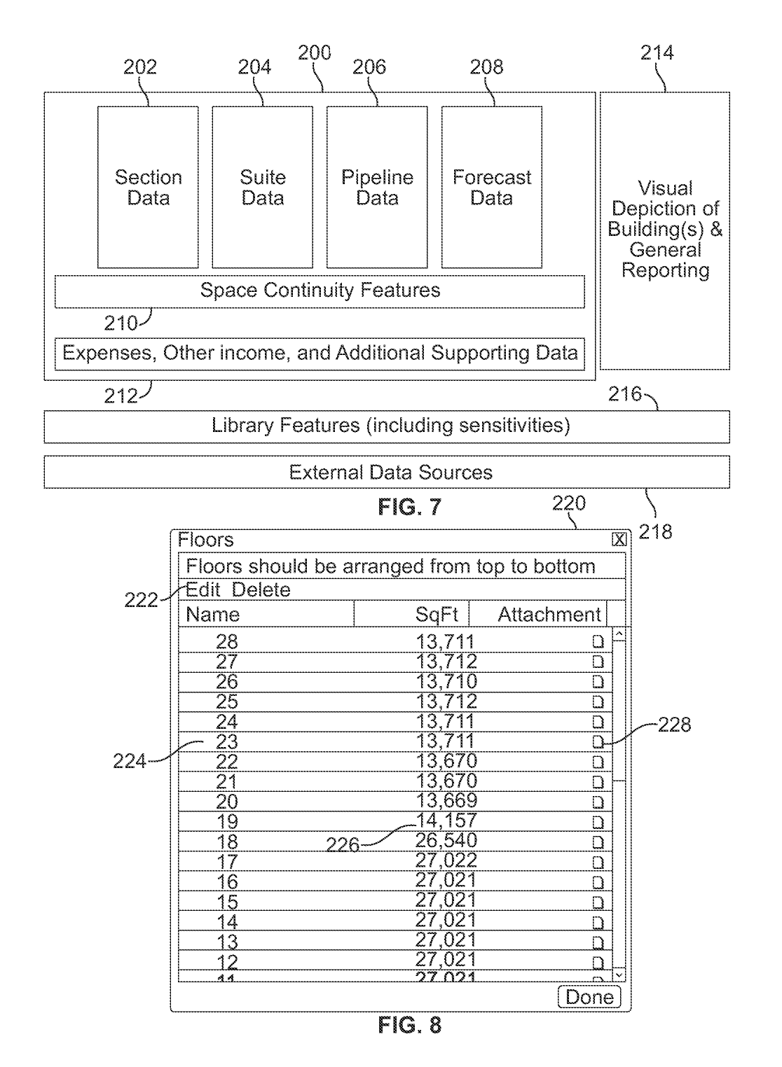

Referring to FIGS. 7-8, a property file 200, similar to property files 76-100 (FIG. 5), may contain data directly in the property file, or may contain links to data sources outside of the property file (a library, pipeline, or forecast data, for example, contained in separate files within the program or in files outside of the program that are accessed through the API) In one form of a property file 200, it has at least section data 202. The section data 202 is provided by, for example, data entry in a section interface 220 (FIG. 8). Section data 202 is used to allocate a property's area between sections, such as floors, or different types of space such as in-line retail space, anchor retail space, and so forth. While the illustrated section data interface 220 allows for multiple sections, in other forms, the section data 202 could be restricted to a single entry. The user interface 220 also includes an area for adding sections (not shown), as well as an area 222 for editing and deleting sections, an area 224 for naming sections, an area 226 for assigning an area measurement to each section, and an area 228 for adding additional information, such as attachments for each section. While not illustrated here, in some forms, the user interface 220 may be customized for a particular user or group of users in various ways. For example, if a user's preference for defining sections is different than “Floors” as shown in the example, the default value can be changed to another form of defining sections such as clusters of space in a shopping mall (for example, anchor tenants, in-line tenants, and so forth). Similarly, if a user's desired area measurement is known, measurement area 226, which shows square feet (“SqFt”) in this example, can be changed to reflect any unit of area measurement. The remaining data sections in property file 200 are optional.

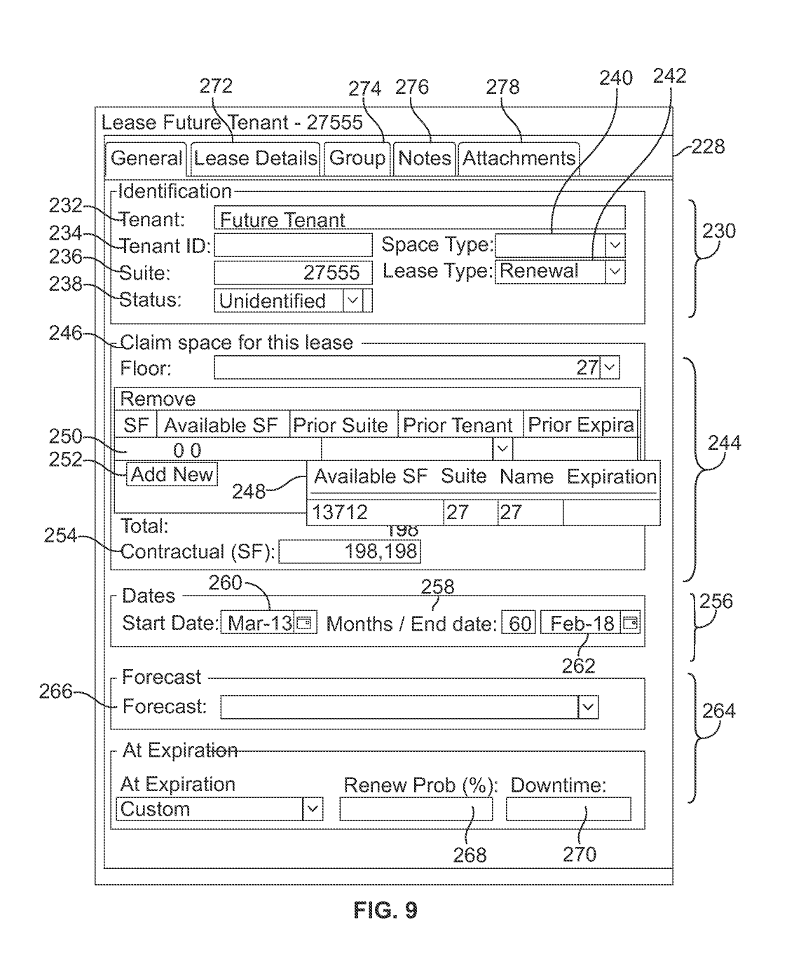

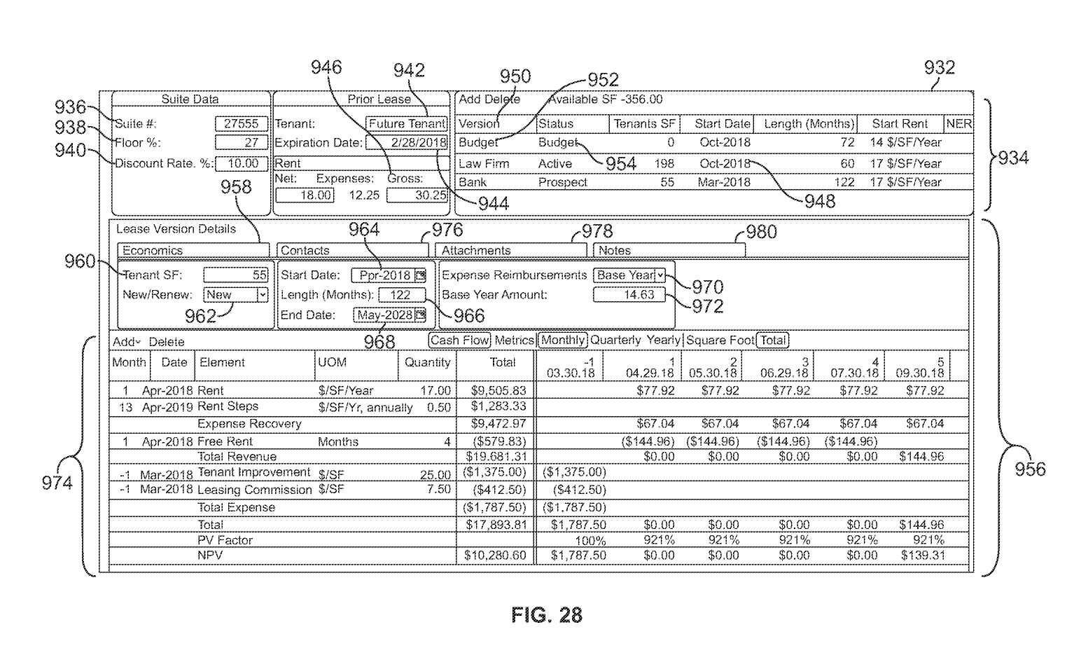

Referring to FIGS. 7 and 9, the illustrated property file 200 also has suite/lease data 204 input by a user through a suite/lease interface 228 to input data about a lease in a building. Alternatively, the suite/lease data 204 may be provided by either an internal or an external application by way of a pipeline interface 932 (FIG. 28) explained below. The suite/lease interface 228 includes a lease identification section 230 that includes various user input controls 232-242 for specifying general identifying information about the lease. The illustrated user input controls include a user input control 232 to specify a tenant's common name, a user input control 234 to specify a tenant's ID (typically a code so that other programs will recognize the tenant), a user input control 236 to specify a tenant's suite (an alphanumeric identifier to identify the tenant's location in the building), a user input control 238 to specify the current status of the lease (executed, pending signature, active prospect, for example), a user input control 240 to specify the type of space occupied by the lease (low-rise office, retail pad, flex industrial, and so forth), and a user input control 242 to specify the lease type such as new lease, renewal, option, for example. In other forms, a greater or lesser number of identifying elements may be specified.

The suite/lease interface 228 also includes a space allocation section 244 that includes various user input controls 246-254 used for allocating space in the building to the lease. The illustrated user input controls include a user input control 246 for a user to select a section of the building. The user may then select space from a pull-down list 248 of space available in the section, which may consist of other leases within the section as well as space available within the section itself. A user input control 250 permits a user to allocate, or claim, space to the lease (as an example, 13,712 square feet may be available from another lease or section, but it may only be necessary to allocate 5,000 square feet for the current lease input). A user selectable control 252 permits a user to add additional allocations of space (consisting of additional inputs with controls 248 and 250), and a user input control 254 to specify, if necessary, a contractual unit of area that is different than the space allocated to the lease (this occurs if a landlord agrees to financial terms of a lease that are based on a stipulated amount of space that is different than the actual space of the lease).

The interface 228 also includes a date selection section 256 for specifying the dates of the lease. For this section, a user input control 258 is provided to enter a start date, a control 260 permits entry for the length of the lease in months, and a control 262 allows for an end date. In this form, the user can enter data in any combination of two of the user input controls 258, 260, 262, and the third variable is calculated. In other forms, there may be different ways to establish the start and end dates of a lease. Further, in this form, the start date of the lease must occur after the latest expiration date of the space selected in the space allocation section 244. In other forms, this logic may be enforced in different ways, or not enforced at all. For example, if dates are chosen first, then the space allocation section 244 may restrict the available space to those that are available on or before the start date of the lease, or the interface 228 may allow the user to select space allocation and date without restriction, and either warn the user of any conflicts, or allow leases with conflicting dates to be incorporated into calculations. This may happen, for example, if a lease is terminated prior to its original expiration date and a new lease is created to take over the space prior to the original expiration date.

The remaining section 264 of the suite/lease interface 228 includes various user input controls 266, 268, 270 for associating a forecast (simulated future leases) with the space that may be applied after the end date of the current lease. One user input control 266 specifies a forecast (created elsewhere in the program), another user input control 268 specifies the probability the current lease will be renewed, and a user input control 270 specifies the downtime (months the space is vacant) if the tenant under the lease decides not to renew. The forecast determines the treatment of the space if no future tenant is identified. The use of a forecast is optional. Therefore, in other forms, section 264 may not be provided.

In addition, several user-selectable navigation tab controls are also shown on suite/lease interface 288 to allow a user to view, input, and edit other information. The economic terms of the lease are available on the lease details tab 272. The groups that the lease is a member of (for example, furniture stores, law firms, and so forth) are available via the group tab 274. Notes about the lease are available via the notes tab 276, and documents associated with the lease are available via the attachments tab 278.

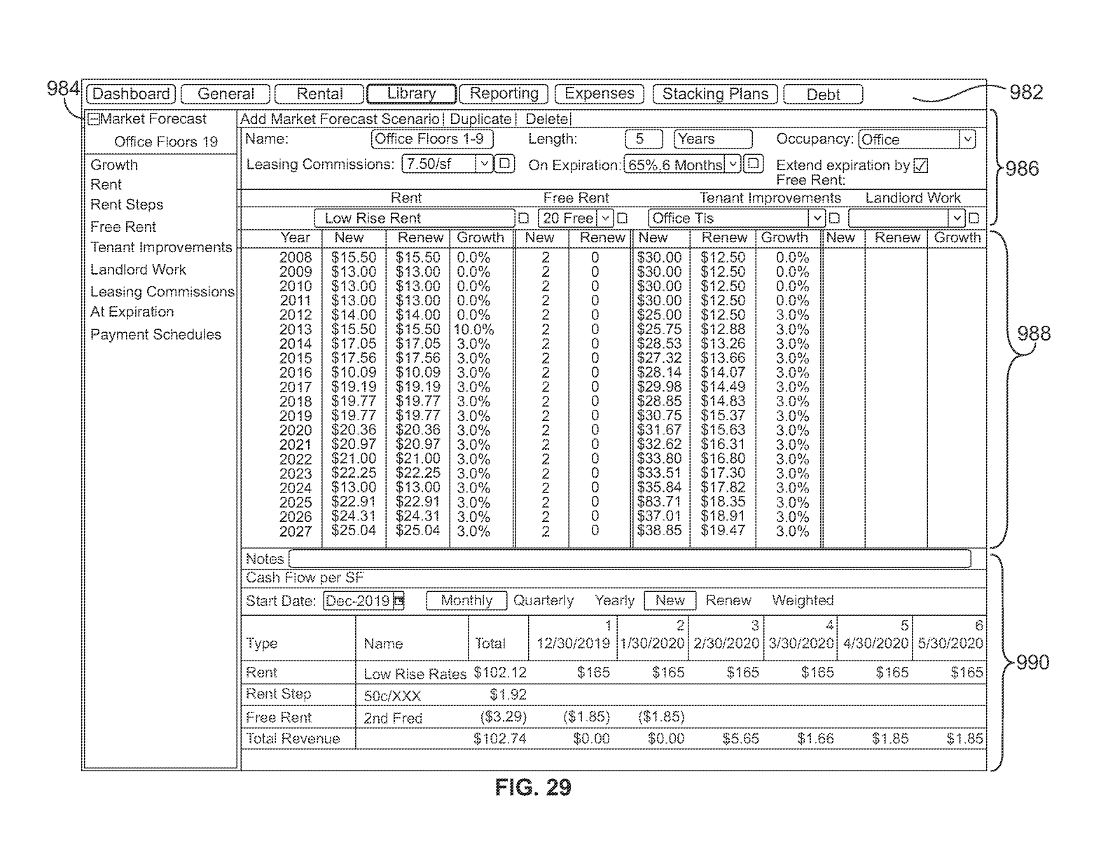

Referring again to FIG. 7, other sections of the property file 200 relate to predicting simulated or future leases. Pipeline data 206 relating to leases currently in negotiations is provided by, for example, a pipeline interface 932 (FIG. 28) either within the current program, or through an external application that accepts pipeline data. Forecast data 208 is provided by, for example, a forecast interface 982 (FIG. 29). In the illustrated form, the forecast data 208 is closely related to a library (including linking features and sensitivities). In other forms, it may be a freestanding feature or file, separate from the Library. For example, the forecast data may be provided by a third party service provider, an external database, or a combination of sources (direct entry, third party provider, external database, to name a few examples). The interfaces for the forecast and pipeline data are described in greater detail below.

Likewise space continuity features 210 refers to the collection of rules enforced throughout the program which make it possible to trace the use of space over time, as well as the rules that make it possible to apply filters to different components which can include, exclude, and shift the timing of leases and associated calculations. Space continuity features bring together data from a number of different places in the program such as the section interface 220 where spaces are defined (FIG. 8), the suite/lease interface 228 (FIG. 9) and specifically the lease space information in section 244, the pipeline interface 932 (FIG. 28) and specifically the suite data and prior lease area of section 934), and the forecast interface 982 (FIG. 29), which is designated in area 264 of the suite/lease interface (FIG. 9). The space continuity features are described in greater detail below. The property file 200 provides for expenses, other income, and additional supporting data 212 for the user's information and calculations by the program.

As mentioned above, the property file, in one form, has at least section data 202. The section data 202, in combination with only certain ones of the other types of data, may form a specific purpose property file. For example, if a property file 200 only has the section data 202 and either the pipeline data 206 or forecast data 208, then the property file 200 will only provide that data. This is the same for any of the optional data types at the property file 200.

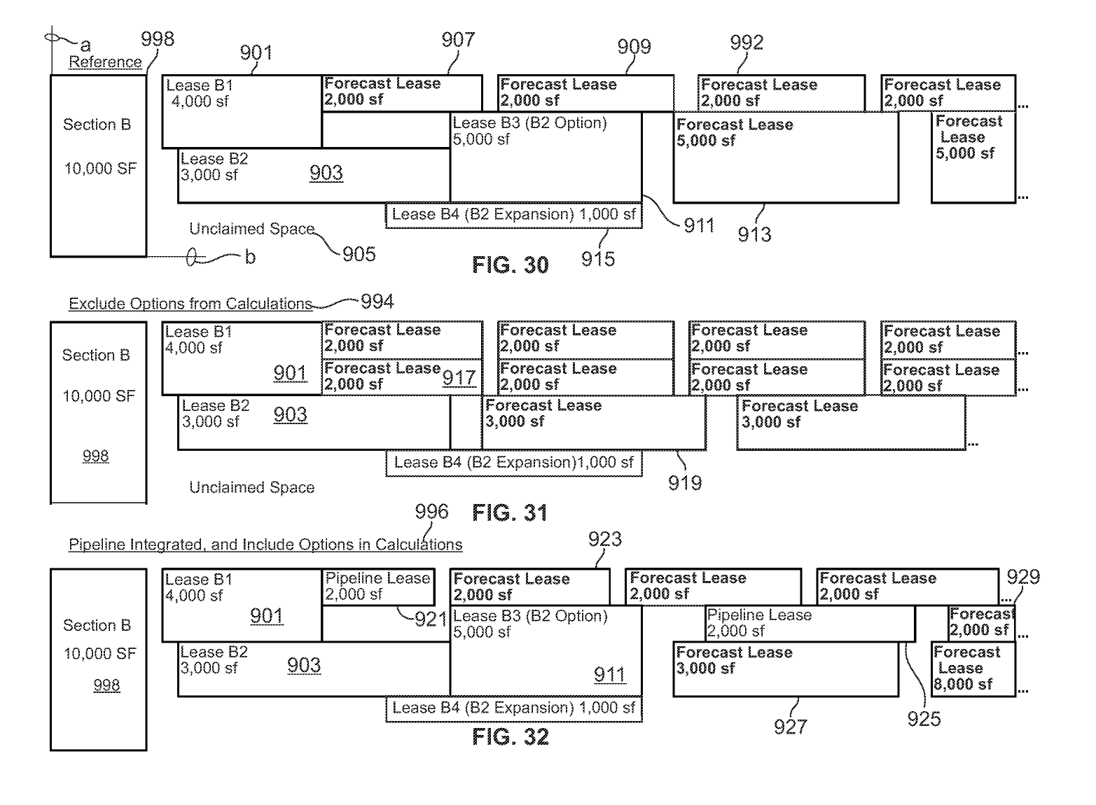

Other data are closely associated to the property file 200, and may or may not be considered part of the property file. Visual Depiction of Building(s) and Reporting Features 214 represent the presentation of inputs and calculations based on data and user selections throughout the program. These features can be applied to both an individual property, or a user defined group of properties. These features relating to the display of space continuity are described below and illustrated on FIGS. 30-33.

Referring to FIGS. 5 and 7, library features (including sensitivities) 216 refers to the library features illustrated on network 60 (FIG. 5) and includes data which may be referenced by the corresponding property file 200. Thus, though a library file is not part of a property file, the two are closely integrated, and, in one form, each property refers to a library file. Each property 76-100 is associated with a library 62-74 that provides a single point of entry for key assumptions that are used throughout the program and are considered part of the library features 216. The forecast interface 982 (FIG. 29) is part of the library as well (it is the data from this that is referenced by item 208 in the property file 200).

External data sources 218 refer to external data sources 125 (FIG. 5) that the program may access. For example, through its API, the program may access data provided by property accounting systems, data provided by lease pipeline programs or applications, historical or forecast data provided by third-party data providers, or any other form of external data that may be useful in the compilation of property and/or library data. The API may also allow two-way access, so that external systems may be able to access data within the program, which may include data within both library files and property files.

### IV. Linking/Unlinking Properties to Libraries

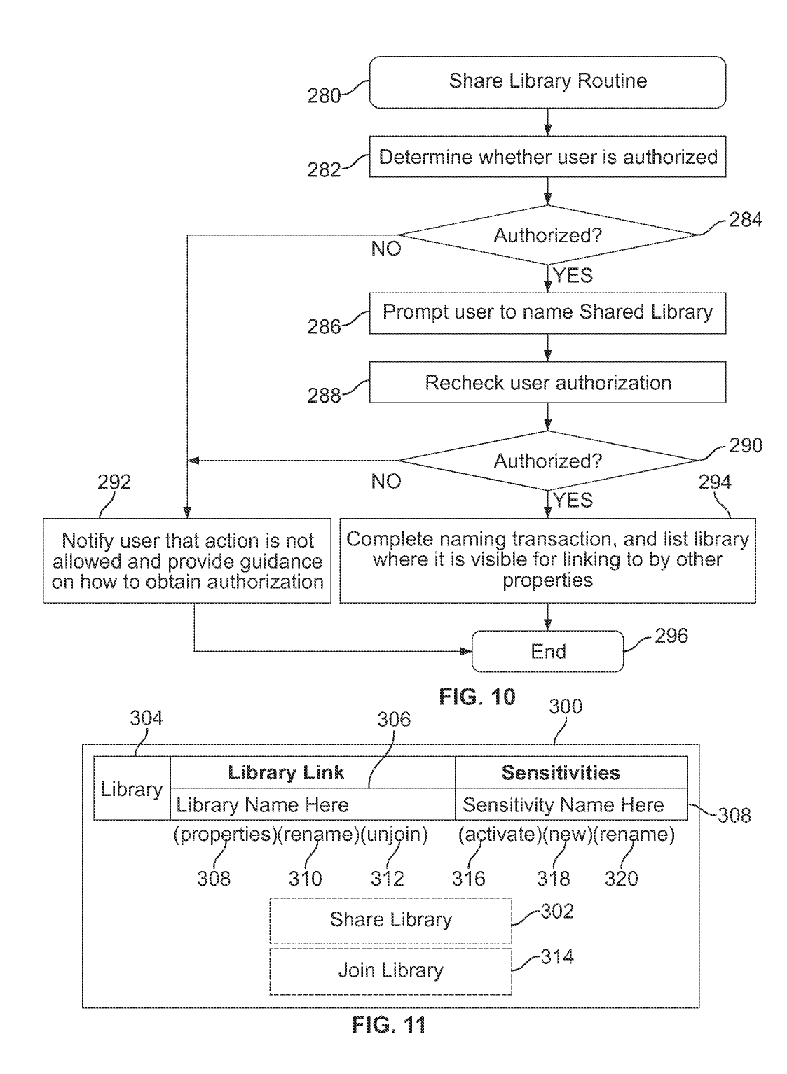

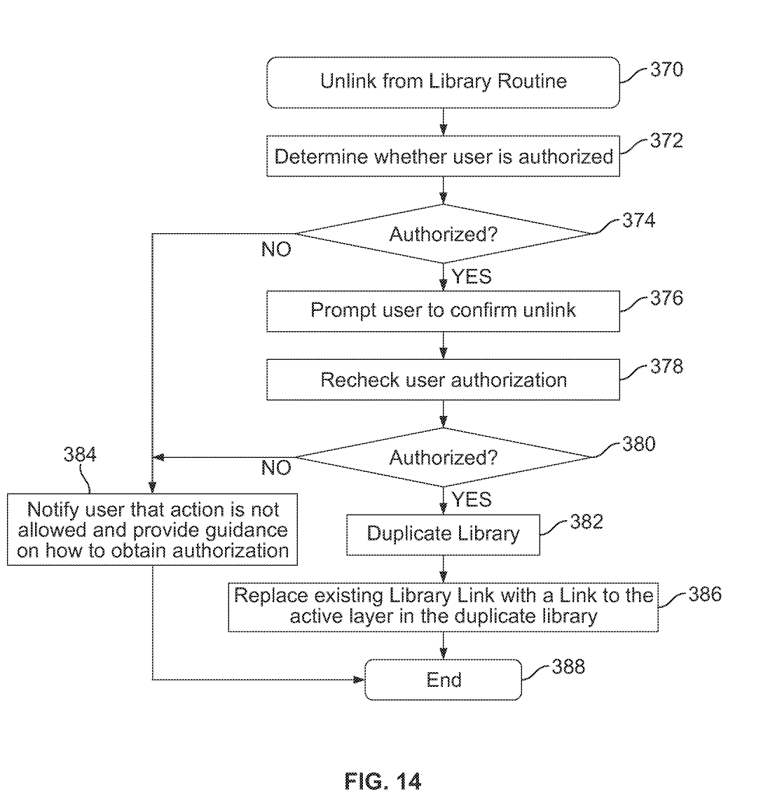

Referring to FIGS. 10-11, in order to link more than one property to a library, the library must first be specified as a shared library in a share library routine (280). If only one property is to be linked to a library, this step can be omitted. In one form, the routine is initiated on a library function interface 300. The interface 300 contains a button 304 which is used to open a main library interface 500 (also referred to as simply opening the library) (FIG. 15) and a market forecast interface 982 (FIG. 29), a display area 306 for the name of the library a property is linked to, a properties button 308 to provide a list of other properties linked to the shared library, a rename button 310 to activate a dialog to rename the shared library, and an unjoin button 312 to activate the unlink routine (370) (FIG. 14) to remove the property's link to the shared library. The library function interface 300 is shown in a state when a property is linked to a library. If the property is not linked to a shared library, buttons 308, 310, and 312 are not visible, and the display area 306 may be replaced with a join library button 314, and a share library button 302 (both shown in dashed line). Otherwise, the two buttons 302, 314 may be shown at other locations on the interface 300, and the library link area 306 may be blank for example.

If the “share library” button is selected, the share library routine (280) is launched, and the system 10 first determines (282) if the user is authorized to execute the routine. Generally, the authorization may include verifying that the user is an authorized user for the overall system, that the user is authorized to use the specific feature, and that the user is authorized to utilize the specific feature for a specific property or properties (hereinafter the “authorization” routine). The library function interface 300 or other interface may also include visual cues, such as active or inactive buttons, based on which features the user is authorized to access. Many of the processes described herein use the same or similar authorization routine and this may include the visual cues or restrictions on whichever interface is relevant to the process being performed.

If the user is authorized (284), the system 10 prompts (286) the user to enter a name for the current library which is to be shared. After the user enters a name for the library, the user's authorization to complete the routine is checked (288) again before the data is committed to the database. Other forms of the routine may include fewer, or additional authorization checks, as well as greater or lesser integration of the authorization process into the user interface. If the user is authorized (290), the naming transaction is completed (294) by adding the library name to the library, and it thus becomes a shared library, making the library visible to users so that the library is listed where other properties can then link to the shared library. If the user is not authorized (284 or 290), the system 10 provides a notification (292) to the user that may explain that he or she is not authorized to complete the routine, provide information on why the user is not authorized, and/or provide guidance on what steps can be taken to obtain authorization (for example, sign-up for the feature). This authorization step is the same or similar to that in the other processes herein. After the completion of either the notification (292) or naming/listing transaction (294) the routine ends.

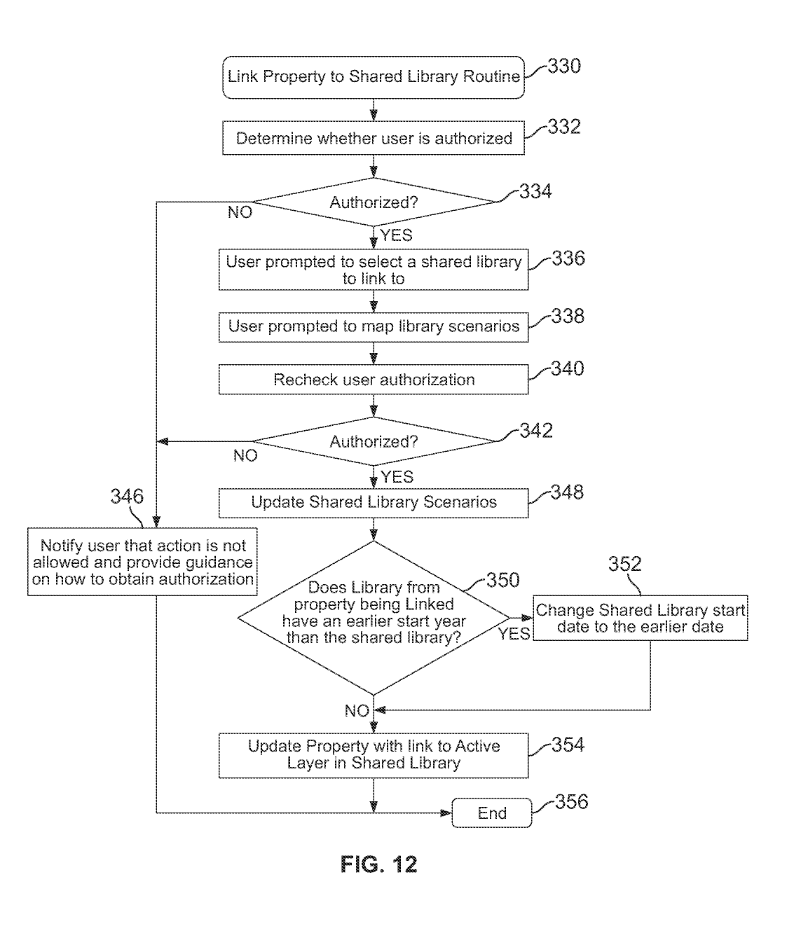

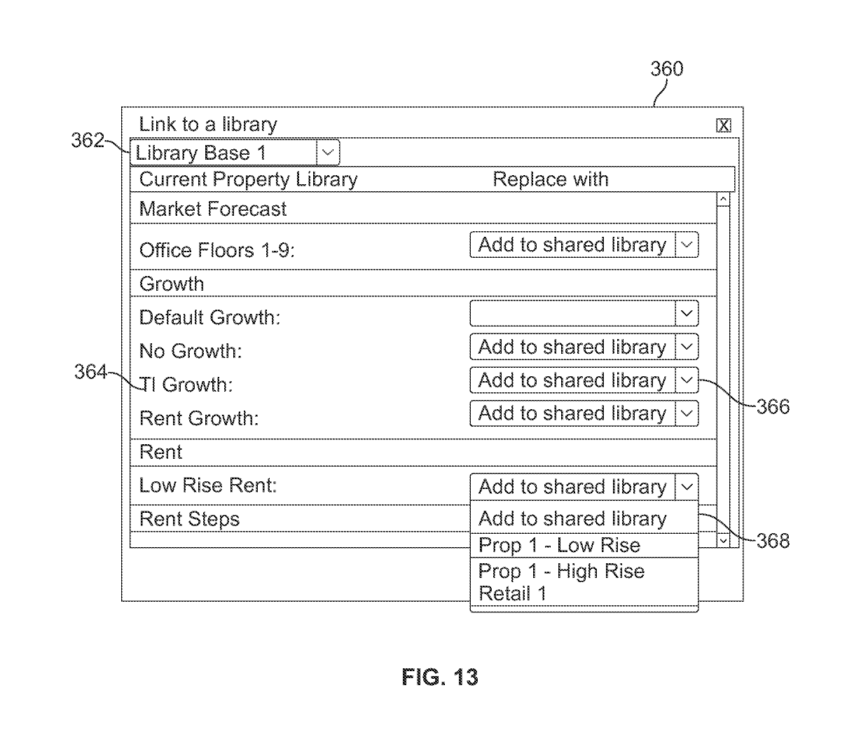

Referring to FIGS. 11-13, if the “join library” button 314 is selected on the library function interface 300, a user is walked through the process (330) of joining a library that is already currently shared. The routine (330) to link property to a shared library begins with an authorization routine (332, 334) that is the same or similar to the authorization routine (282, 284) described above to determine if the user is authorized to indicate a library is to be shared (280) (FIG. 10). If the user is authorized (334), the user is prompted (336) to select a shared library to link to from a list of shared libraries, such as those, for example, shared through the execution of the share library routine (280) (FIG. 10). After the user selects a shared library, the user is prompted (338) to map the sub-elements in the current library (i.e. the one the property is being de-linked from) to the sub-elements in the shared library the property will now have a link to.

A link to a library user interface 360 permits a user to map an existing property that may already be associated with a library to a linked or shared library. A user may select a library from a list of shared libraries via a drop-down menu or other control 362 on the interface 360. Once a shared library is selected, the interface 360 is populated with sub-elements included in the library currently in use by the property. One sub-element 364 in the illustrated example is TI Growth. For each sub-element the property references in the current library, the user must choose to either add the sub-element to the shared library, or replace the sub-element used in the current library with one from the shared library. In the illustrated example, this is accomplished through the use of a pull-down selection for each scenario or sub-element as illustrated by user input controls 366 and 368.

After the completion of the mapping (338), the user's authorization to complete the routine is rechecked (342) before the data is committed to the database as with the share library routine (280), and the user is provided (346) the same or similar notification if the user does not have proper authorizations. If the user is authorized (342), the shared library is updated (348) with the results of the mapping (338). Then, the start date (or year) of the current property file is compared (350) to the start year of the shared library the property is being linked to. If the current property file has an earlier start year, the start date of the shared library is changed (352) to the earlier date so that library data is available for all properties linked to the library. Date conflicts between properties and libraries can be resolved in many ways, and other forms may contain different methods. After the date has been changed (352) or if it has been determined that no date change was necessary, the current property is updated (354) with a link to the active layer in the shared library, and the routine ends (356).

The updating of the property with a link to a library may occur in multiple ways. In one form, the shared library data is stored in a single location, and updating the link involves updating data to identify the location. In other forms, shared library data (and specifically the data corresponding to a single property file or the library features) may be saved in multiple locations (for example, a separate copy for each property, rather than a link to a freestanding library).

Referring to FIGS. 11 and 14, to unlink a property file from a shared library, the routine (370) may be executed by pressing the “unjoin” button 312 (FIG. 11). The system 10 then determines if the user is authorized (372, 374, 378) to execute the routine as mentioned above for the previous routines. If the user is authorized (374), the user is prompted (376) to confirm the desire to remove the link to the library. Upon the user's approval, the user's authorization is rechecked (378) before the data is committed to the database. If the user is still authorized (380), the shared library is then duplicated (382) to form an independent, freestanding library for the property file to access. In one form, a property file must be linked to at least one library to preserve the scenarios under certain sub-elements and sensitivities used by the property file 200. Then, the reference (i.e. the link) in the property file 200 to the active layer in the shared library is removed (386), and the old reference is replaced by a reference to the active layer in the new, duplicated library data. In other forms, library data may be duplicated and associated directly with the property (i.e. rather than a link to a freestanding library, the library data may be more closely integrated into the property in its corresponding library features memory 216).

After the completion of this step, the property 200 no longer has any link to the shared library, and therefore changes made to the shared library do not impact the property file (or vice versa). The property now has a freestanding library which contains a duplicate of all pertinent data from the shared library. It is also possible to unlink multiple properties from a shared library at once. When this occurs, the properties being unlinked may all be linked to a single, duplicate library file, or may be each linked to their own freestanding, duplicate library file. In other forms, fewer, or a greater number of library sub-elements may be duplicated. For example, only library sub-elements actively referenced by the property may be duplicated, rather than all sub-elements in the library. The routine then ends (388).

### V. Adding Sub-Elements

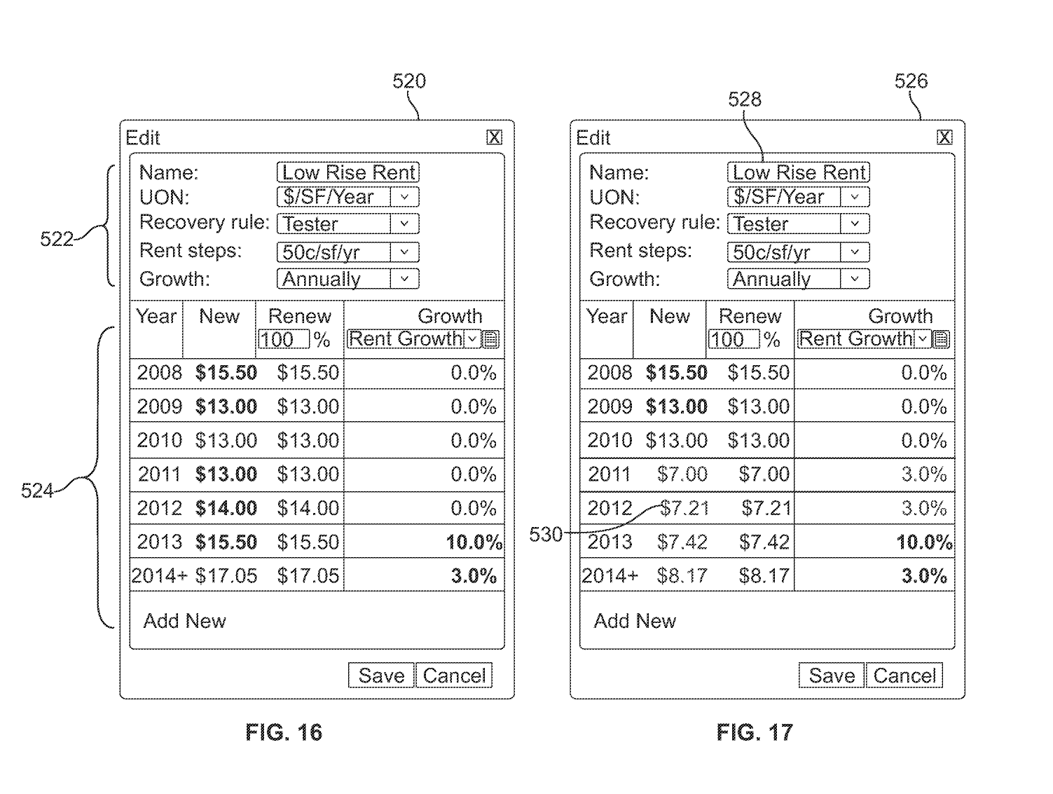

Referring to FIG. 15, a user may use the main library interface 500 to create, delete, enter and view library element and sub-element data. The library interface 500 may include a side menu or other area 502 that lists library elements 512 that can be selected by a user, and a screen area 504 for creating and displaying sub-elements, and here example sub-elements 506, 508, and 510, for a selected library element 512. In the example, the main element or category is rent which is consistent across all libraries, and the sub-element of low rise, mid-rise, or high rise rent are user defined within the library. Each sub-element also has a list of entries or a set of assumptions 518 that are either populated automatically or manually entered by a user. Each sub-element 506, 508, 510 has a set of controls 514, including control 516 to launch a library input interface 520, 526 (FIGS. 16-17). The sub-elements 506, 508, 510 edited in this example user interface 500 are made available for calculations to: the forecast interface 982 (FIG. 29) which is also part of the library, the suite/lease interface 228 (FIG. 9), and a variety of calculations throughout the program. In other forms, it may be possible to edit the sub-elements in-place (i.e. no need to launch a separate pop-up), and there may also be additional elements (such as valuation metrics, transaction expenses, loan terms, interest rate curves, and financing expenses), or fewer elements.

Referring to FIGS. 16-17, a sub-element interface 520 permits a user to enter data for one of the many different possible library sub-elements, such as a rent sub-element. In this example, the user interface 520 includes an area 522 where general information about the rent sub-element is entered, and an area 524 where rents (a set of assumptions 518 for example) are entered, and where rents are calculated for fields without entries. It will be understood that instead of a separate interface 520, the sub-element data could be entered directly on the library interface 500.

### VI. Adding Sensitivity Layers

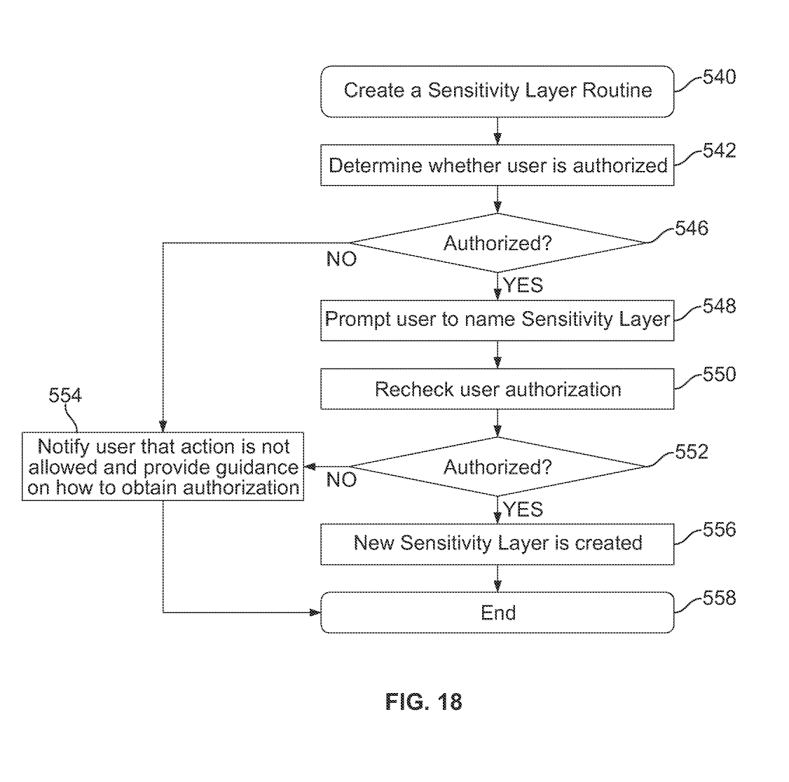

Referring to FIG. 18, a sensitivity layer creation routine (540) may be executed, in one example, by pressing the “new” button 318 by the sensitivity window 308 on the library function interface 300 (FIG. 10). The sensitivity routine (540) first uses the same authorization routine (542, 546, 554) as in the other routines. If the user is authorized, the user is prompted (548) to name the to-be-created sensitivity layer. After the user enters a name, the user's authorization is rechecked (550, 552), and a new sensitivity layer is created (556) so that it may be selected on a sensitivity layer interface 308 (FIG. 11). In one form, a sensitivity layer consists of an identifier and storage of variances versus the baseline library. In other forms, the entire library, or portions of the library, may be duplicated so that a sensitivity layer can include a duplicate library with changes, rather than the variances only which are tracked in the system 10.

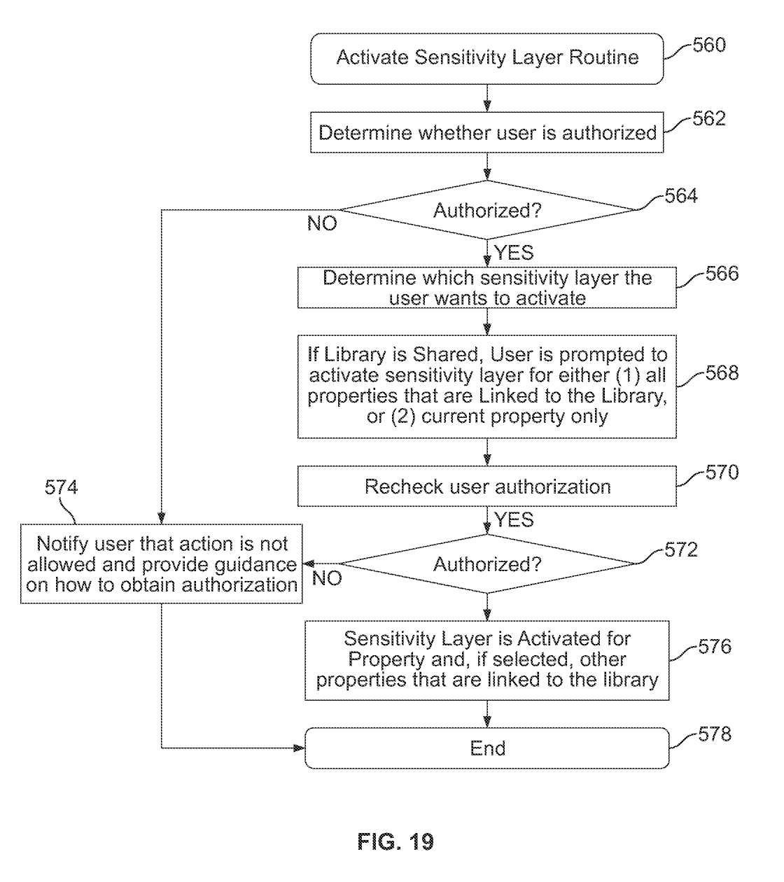

Referring to FIG. 17, a sensitivity interface 526 presents the same rent sub-element as in interface or sub-element 520 except as viewed from a sensitivity layer. The user may enter or change values on the sensitivity interface 526 to create a different set of assumptions 530, and the changed assumptions are then highlighted, separated, or indicated on the interface 526 in some other way. These changes may also be viewed for multiple sub-elements within the library interface 500. An unlimited number of sensitivity layers may be created for each library through the routine (540) (FIG. 18). In one form, each sensitivity layer represents a different set of assumptions where at least one assumption is different than on any other layer (for example, strong rental market, weak rental market, recession, and so forth) that will be applied throughout the property when the sensitivity layer is activated (FIG. 19). In other forms, a property may access multiple layers within a library at the same time. For example, it may be possible to calculate some leases using one layer and other leases using a separate layer. The key differences between a baseline sub-element interface 520 (FIG. 16) and a sensitivity layer sub-element interface 526 is that the field 528 for entry of the name of a sub-element may not be edited in a sensitivity layer interface 526, and of course, the sensitivity layer may have the different values for the assumptions 530 in the same time period (for example, a rent sub-element), or other units as that recited on the sub-element interface 520. Other than the sub-element name 528, in one form, all entries in a sensitivity layer may be edited to create different assumptions for a specific sub-element.

Once the sensitivity name is formed and the sensitivity layer is populated, the sensitivity layer can be selected on the control 308 on the library function interface 300 (FIG. 11), and, in one example, a button 316 pressed for activation of the named sensitivity layer. This also displays the sensitivity on the forecast interface 982 and the library interface 500. The library function interface 300 also includes a button 320 to rename the current sensitivity.

Referring to FIG. 19, once button 316 is pressed, an activate sensitivity layer routine (560) begins the authorization routine (562, 564, 574) as in the other processes. If the user is authorized (564), the program then determines (566) which sensitivity layer is to be activated, such as through a user selection prior to selecting the activate button for example. Next, if the library is shared, the user is prompted (568) to activate the sensitivity layer for all properties that are linked to the shared library or only the currently active property. The user's authorization is rechecked (570, 572) before the sensitivity layer is activated (576) for the current property, and, if selected, other properties that are linked to the same library. The routine then ends (578).

In other forms, it may not be necessary to activate a sensitivity layer. For example, the sensitivity layer may be automatically activated when it is selected. The activation routine, however, enables editing and viewing of the sensitivity layer without impacting calculations until it is activated. Also, the system 10 may not provide the user with the option of activating the sensitivity layer for all properties linked to the shared library. Alternatively, the concept of active versus inactive sensitivity layers may be eliminated entirely. For example, even within the system 10, it is possible to compare calculations based on different sensitivity layers even when the sensitivity layers are not active. This may occur indirectly, for example, when comparing resulting cash flows from “downside” sensitivity with cash flows from an “upside” sensitivity on an interface displaying calculation results without the need to bring up or activate the related sensitivity layers themselves.

### VII. Workgroups

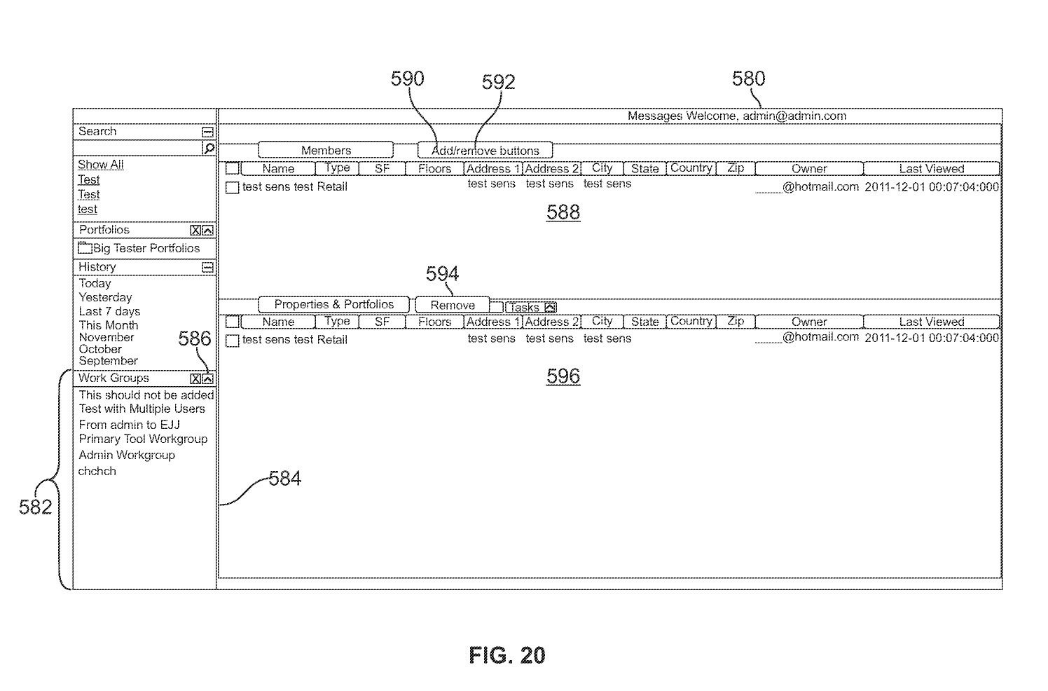

Referring to FIG. 20, as mentioned above, a workgroup, such as workgroup 110 or 112 (FIG. 5) for example, is a group of authorized users that may have access to one or more properties, and the libraries associated with those properties. The members of a single workgroup may or may not be from the same company, and the members of the group may be provided access to the system 10 because it was deemed convenient, efficient, or economical to do so.

The system 10 provides a workgroup user interface 580 so that an authorized user may manage workgroups. The workgroup interface 580 includes an area 582 with a workgroup selection section 584 for a user to select, view, and edit data about an existing workgroup. The area 582 also has a user control 586 to create or delete workgroups. For example, pressing on a new workgroup button in the area 582, as one example, may automatically make the user the default workgroup administrator for the new workgroup, and allow the user to name the workgroup and add members.

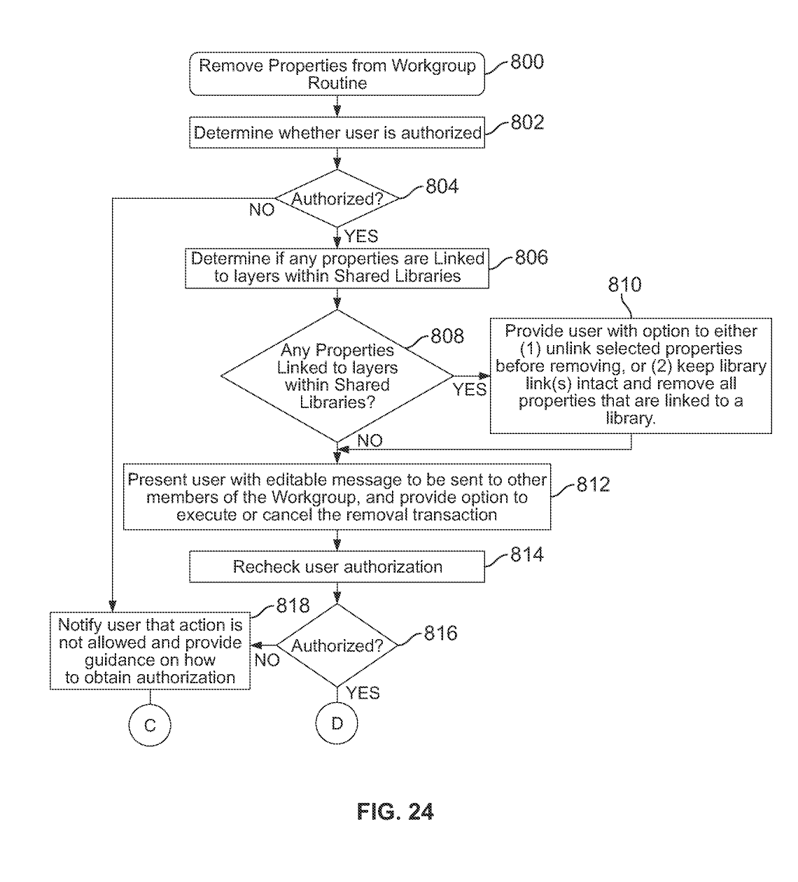

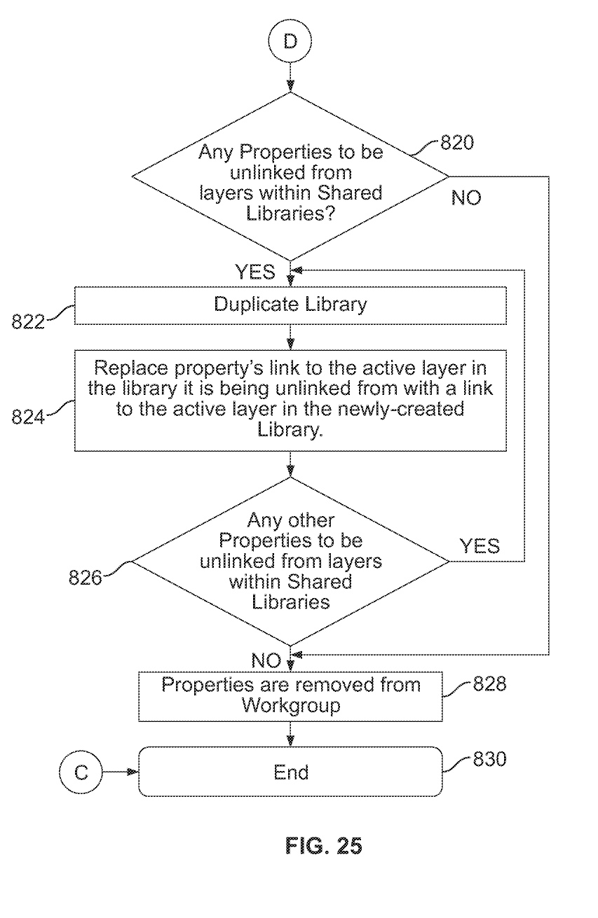

The example workgroup interface 580 also includes an area 588 displaying the members of the selected workgroup, and user controls 590-592 available to users with administrative privileges for the workgroup. Administrative privileges may include the ability to transfer workgroup administration privileges, adding or removing a user from the workgroup, removing a property from the workgroup, admitting a property to the workgroup, and/or deleting a workgroup. There may be more or less as desired, and some of these feature such as adding or removing a property to a workgroup may be permitted for non-administrative users of the workgroup. For the current workgroup interface 580, administrative control 590 is used to add members to the workgroup. Administrative control 592 is used to launch a dialog to remove members from the workgroup. Another part of the example user interface 580 is the properties and portfolios (a folder of a group of properties) display area 596, where properties that are part of the selected workgroup are displayed. If the selected workgroup contains shared portfolios, the properties can be grouped by a hierarchy established in the shared portfolio if one exists. User control 594 is provided for purposes of removing properties from the workgroup. For instance, a user with administrative privileges for the workgroup can select one, or multiple, properties, and then select the control 594 to activate the removal routine (800) (FIGS. 24-25).

The user who is designated as the workgroup administrator can also transfer administrative privileges to any other member of the workgroup. This may be provided by the workgroup manager or other program component with an automatic routine. For example, if the user presses a transfer admin button on the workgroup interface 580, the user can be prompted for the user name of the desired person to assume administrative duties. That person may then be sent an email or other message to confirm the transfer of the administrator title and duties.

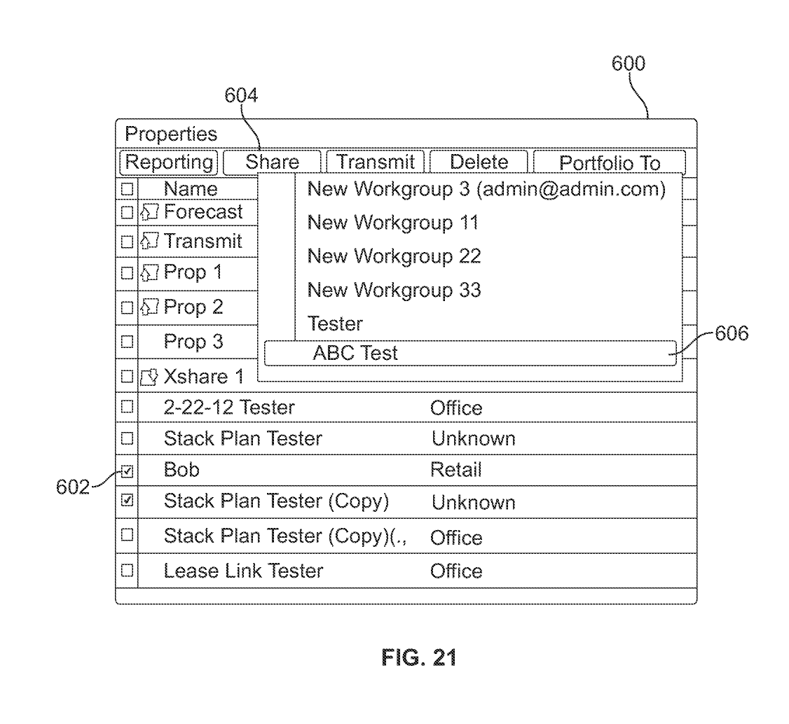

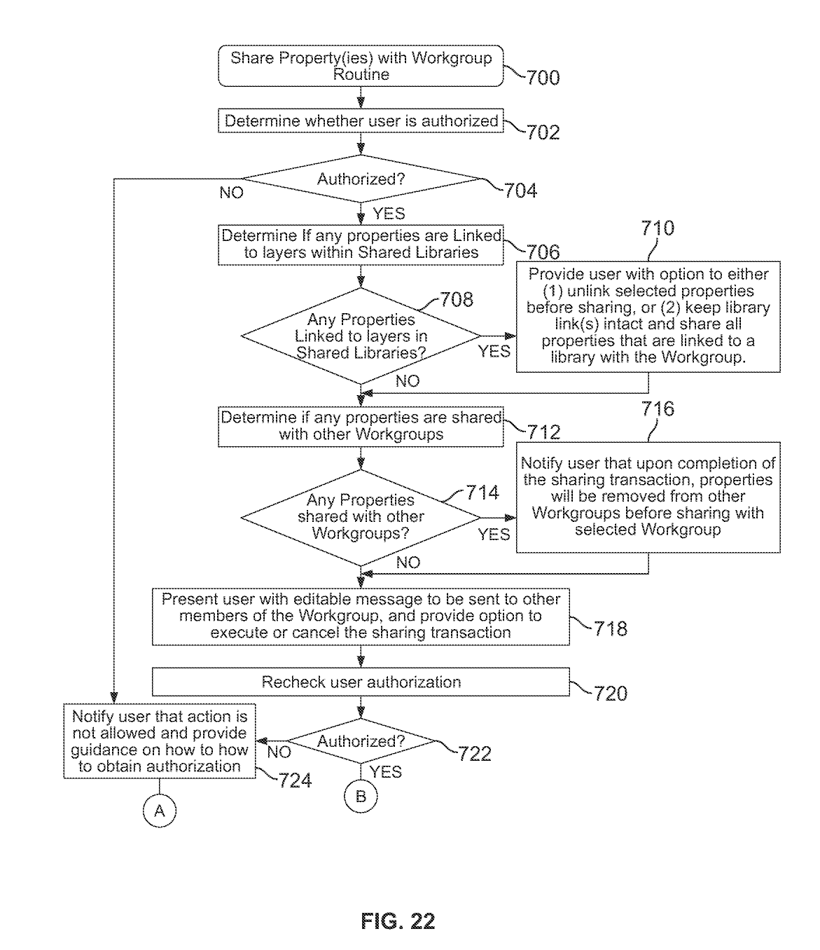

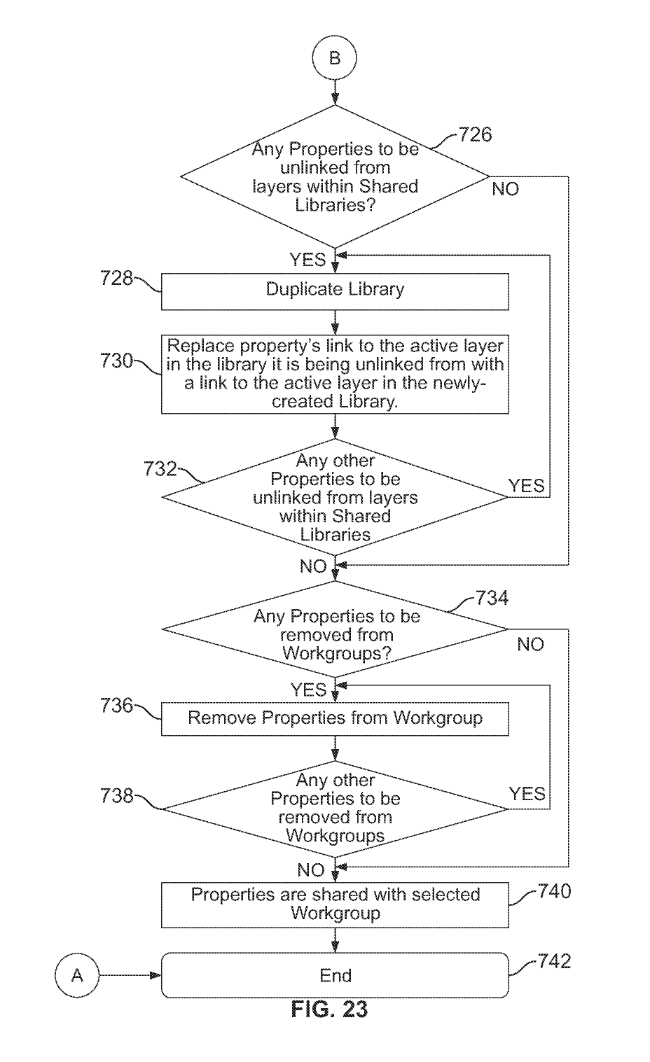

Referring to FIG. 21, a properties interface or 600 permits a user to share properties with a workgroup. In this example, the interface 600 includes a control 602 such as a check box or other device to permit a user to select one or multiple properties. A control 604, such as a share button, activates a share menu 606 that lists workgroups that can be selected to place the property (or properties). When a workgroup is selected, it activates a sharing routine (700) (FIGS. 22-23).

Referring to FIGS. 22-23, a routine (700) is provided to share properties with a workgroup. Once activated, the share properties routine (700) uses the authorization routine (702, 704, 724) similar to that described above for the other routines herein. If the user is authorized (704), the system 10 determines (706, 708) if any of the properties to be shared are currently linked to layers within shared libraries that are not linked to the workgroup. If so, the user is given (710) two options. The user can unlink the properties from the outside shared library before sharing the properties with the workgroup. Alternatively, the user can bring the outside shared library entirely within the workgroup by keeping the links to the outside shared library, and the layers within the outside shared library, intact, and sharing all of the properties that reference the outside shared library with the workgroup.

In one form, when a library is linked through properties to a workgroup, all of the properties that reference a shared library must be shared with the single workgroup so that it is not possible for someone outside of the workgroup to make a change that impacts properties in the workgroup. This assists to inform the users as to who can make changes to the properties or layer data when it must be someone within the workgroup. This is even more precise for the duties that can only be performed by the workgroup administrator that is known to all of the members. In other forms, properties that reference a shared library may be accessible to multiple workgroups.

After the user makes (710) a selection, or if no properties are linked to layers within outside shared libraries, the system then determines (712, 714) if any of the properties are currently shared with other workgroups. If such property sharing exists, the user is notified (716) that upon completion of the sharing transaction, properties that are currently shared with other workgroups will be removed from those workgroups.

After the notification (716), or if no properties are shared with other workgroups, next the user is presented (718) with a modifiable message that will be sent to other members of the workgroup notifying them of changes that will occur due to the previous steps and upon completion of the routine (700). The user's authorization to complete the routine (700) is then rechecked (720, 722), before the data is committed to the database. If the user is authorized (722), based on the user's selections (710), the system 10 determines if any of the properties to be accessible to the workgroup should have links to layers within shared libraries outside of the workgroup that were, or will be, removed. If it is determined (726) that links to layers within outside shared libraries are to be removed for certain properties, then for each such property, the shared library (including all layers) are duplicated (728). After the outside shared library is duplicated, the property's link to the active layer in the outside shared library is removed (730), and replaced with a link to the active layer in the freestanding, duplicate library.

After the linking to a freestanding library (730), the system 10 determines (732) if any other properties need to be unlinked from layers within outside shared libraries. If additional properties are identified, the duplication-removal step (728) is repeated for each property. In other forms, a subset of the properties referencing a shared library may be allowed to stay in place. For example, in the current form, if properties A, B, C, X, Y, and Z all reference an outside shared library but only properties X, Y, and Z are to be added to a workgroup, then a separate freestanding library is created for each of properties X, Y, and Z. The user may also be given the option to create a single, duplicate, shared library immediately for properties X, Y, and Z so there is no need to re-link the properties to a shared library after they are added to the workgroup.

If the system 10 determines (726) no properties, or no more properties, need to be unlinked from layers within outside shared libraries, the system 10 determines (734) if any properties are currently part of other workgroups, and should be removed from those workgroups before joining the selected workgroup. If so, each such property is removed (736) from its current workgroup. Next, it is determined (738) if any other properties need to be removed from any workgroups. If so, the routine for removal is repeated for each property. If the system determines (732) that there are no properties to be removed from workgroups, or no additional properties to be removed from workgroups, the selected properties are shared (740) with the selected workgroup.

Referring to FIGS. 24-25, a routine (800) is provided to remove properties from a workgroup. The removal routine (800) may, for example, be provided by highlighting a property on the workgroup interface 580 (FIG. 20) and pressing a removal button or other feature 594. The routine (800) begins with the same or similar authorization routine (802, 804, 818) as with the other processes herein. If the user is authorized (804), the system 10 determines (806, 808) if any of the properties to be removed are currently linked to layers within shared libraries within the workgroup. If so, the user is given (810) the option to either unlink the properties from the shared library before removing them from the workgroup, or keep the links to the shared library intact, and remove all properties that reference the shared library from the workgroup.

After the user makes a selection (810), or if no properties to be removed are linked to layers within shared libraries, the user is presented (812) with a modifiable or editable message that will be sent to other members of the workgroup notifying them of changes upon completion of the routine (800). Next, the user's authorization to complete the routine is rechecked (814, 816) before the data is committed to the database. If authorized, and based on user selections, the system 10 then determines (820) if any of the properties should have links to layers within shared workgroup libraries removed. If so, then for each such property, the shared workgroup library is duplicated (822) to form an outside shared library. Then, the property's link to the active layer in the shared workgroup library is removed (824), and replaced with a link to the active layer in the freestanding, duplicate, outside library.

The system 10 now determines (826) if any other properties need to be unlinked from layers within shared libraries. If additional properties are identified, the removal steps (820, 822, 824) are repeated for each property. As with the routine to share properties (except here in the reverse operation), a separate duplicate outside library may be formed for each property, or a single duplicate outside library may be formed for a group of properties that are all being removed from the workgroup and unlinked from a workgroup library or libraries. If it is then determined (826) that no properties, or no further properties, need to be unlinked from layers within shared libraries, the selected properties are removed (828) from the selected workgroup. The routine then ends (830).

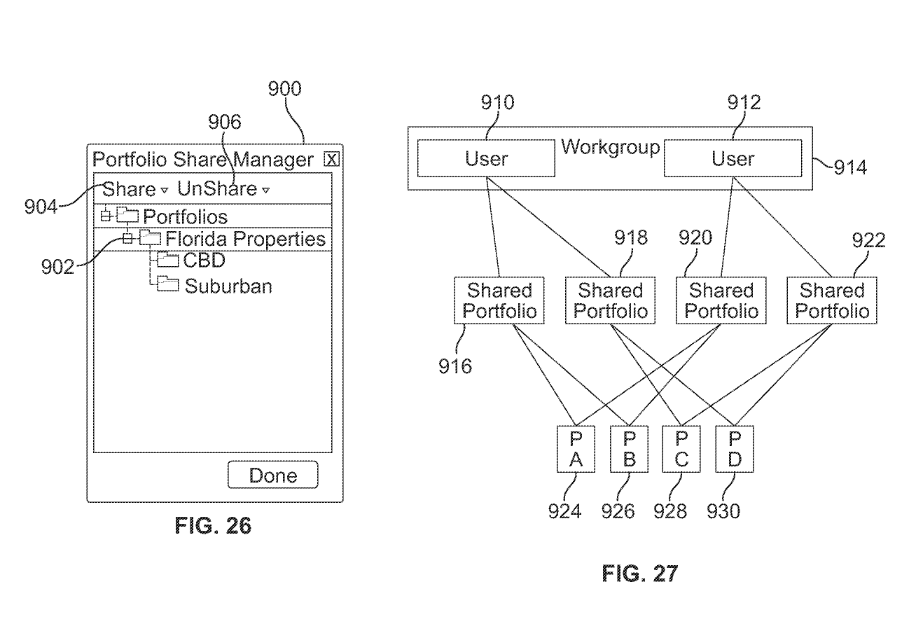

Referring to FIGS. 26-27, as a further aspect of workgroups, the workgroups, and specifically the workgroup manager or portfolio manager, provide another convenient and efficient way to organize a large number of property files into shared portfolios. The shared portfolios are managed on an interface 900 (FIG. 26). The shared portfolios are folders that are present in the portfolio section for each user in the workgroup. Each user has access to the same copy of the portfolio folder. As an example, two users 910 and 912 are members of a workgroup 914 (FIG. 27). User 910 has portfolio folders 916 and 918, while user 912 has folders 920 and 922. Both portfolio folders 916 and 920 have property files 924 and 926, while portfolio folders 918 and 922 both have property files 928 and 930. Thus, if a user in a workgroup adds a property to a shared portfolio, it is then made available in the same folder to all users in the workgroup. This feature eliminates the need for each user to organize files separately. For example, if an investor receives hundreds of properties for evaluation, one user can organize them into shared folders, and then the files will be organized in the same folder system for all users in the workgroup. Otherwise, if hundreds of files are shared, each user would have to organize them, wasting a lot of time.

The portfolio share interface 900 permits a user to share properties with a workgroup, and in particular may designate a portfolio to be shared with a workgroup. Additional properties may be added or removed from the portfolio, and if the portfolio is shared with a workgroup, any properties added will automatically trigger the sharing routine (700) (FIGS. 22-23), and any properties removed will automatically trigger the removal routine (800) (FIGS. 24-25). In this example, the interface 900 has an area 902 to select listed portfolios, and controls 904 for sharing similar to the share controls 604 on the properties interface 600 (FIG. 21). Additionally, a control 906 is provided to allow the user to remove the selected portfolio from a workgroup with which the portfolio is currently shared. After the portfolio is no longer shared any properties added or removed from the portfolio will no longer be shared with a workgroup, unless the portfolio is re-shared.

In one form, the shared portfolios are a list of links to common property files so that the property files do not need to actually be copied multiple times in the same memory or different separate memories. Alternatively, the shared portfolios may be a separate folder in the same memory or stored in a separate memory with a duplicate property file for each user.

### VIII. Lease Types and Identification

The system 10 uses the property data in the system to calculate cash flows, occupancy, and other values associated with a property in order to perform predictive financial analysis for a property or group of properties. In order to understand this aspect of the system 10, the different types of leases used by the system 10 must be understood first.

The leases that can be entered in the suite/lease interface 228 (FIG. 9) include a contractual lease (or an existing lease), a non-contractual lease (which may contain expectations for a future lease), or anything else the user feels like hard coding into the system (entering the data in an interface or downloading the data from another source). The user has the option to select a variety of designations for each lease such as occupancy (office, retail, industrial) or type relative to a prior leases (new, renew, expansion, option) or contract status (contractual, non-contractual, in-negotiation) to name a few examples. Filters can be applied to include/exclude leases from calculations as explained in detail below.

For the example predictive analysis discussed herein, four types of leases are referred to:

a contractual (existing) lease,

an option lease which is a lease that a current tenant has the option to take to extend the existing lease,

a forecast lease which is a simulated lease based on market data and data in the system 10, and

a pipeline lease which is a potential future lease deal that is currently in contract negotiations, and may be updated based on the current lease negotiations. Many other forms of leases may exist based on user inputs (such as non-contractual, expansion lease and so forth). The leases mentioned herein are merely some of the examples used by the system 10, and the system is not limited to the types of leases mentioned herein.

Leases entered in the suite/lease interface 228 (FIG. 9) may be very detailed, particularly if they are contractual. Leases entered in the pipeline and forecast interfaces 932 (FIG. 28) and 982 (FIG. 29) described below will typically (but not necessarily) be slightly less detailed. Any of these types of leases can stand alone (there is sufficient information in each type to generate cash flow calculations and other metrics). Also, each lease can be substituted for the others. For example, if a lease entered in the suite/lease interface 228 is excluded by a filter, it can be replaced by either a pipeline or forecast lease (or nothing at all); depending on the state of other filters the user is applying.

Referring to FIG. 28, an example pipeline user interface 932 permits a user to enter and view general information about a suite, and enter details of potential future lease deals. These potential future lease details are commonly known as the pipeline. The pipeline interface may be present in a freestanding pipeline program or application 125 (FIG. 5), or may be part of a larger program that contains additional property data. The pipeline interface 932 includes an overview area 934 that provides suite data, prior lease data, and the deals that have been entered or imported into the pipeline.

The pipeline interface 932 may include various user input controls for inputting and displaying data about a suite. A user input control 936 has a field for identifying a suite, a control 938 for selecting a floor the suite is associated with (from the data input in the section interface 220 (FIG. 8)), and a control 940 for inputting a discount rate that may be used for certain calculations.

The pipeline interface 932 also may have controls for inputting and displaying data about the previous tenant that occupied the suite. In this example, a user input control 942 is used for identifying the prior tenant, a user input control 944 is used for identifying the expiration date of the lease under which the previous tenant was occupying the suite, and a user input control 946 is provided for inputting the previous tenant's rent at the time the lease expired. The pipeline interface 932 also has a section 948 to receive input from the user and view summary data for each deal in the pipeline. The illustrated user input controls also include a control 950 to add or delete deals, a control 952 for entering identifying information for the lease version, and a control 954 for selecting a status for each lease version. All values may be manually input, or may be imported from an external program.

The interface controls 936-946 may be considered an alternative user interface for key data points obtained in the suite/lease interface 228 (FIG. 9). As an example, the pipeline interface 932 can be part of either a standalone lease pipeline system, or can be integrated into a larger program that contains a suite/lease interface 228 (FIG. 9). In a standalone version, data can be directly entered into controls 936-946, whereas when the pipeline interface 932 is either linked to an external program, or integrated into a program that already contains suite/lease data, these fields may be automatically populated. The same logic applies to the budget lease, budget deal, or simply budget which is an optional lease that can be included in the pipeline. The budget lease typically represents expectations for how the suite will be leased, and provides a benchmark against which other leases can be judged. For example, the budget lease may be imported from the external pipeline program 125 (FIG. 5) for use in the display and calculation of the budgeted deal within the pipeline interface. The standalone lease pipeline system contains section data, suite data, and pipeline data, which creates a property file similar to the actual property file 200 (FIG. 7), and in turn a pipeline lease usable by the space continuity system described below to form financial predictions about a property, adequate to support advanced reporting and visualization (display).

The pipeline interface 932 also may include a deal section 956 which displays data for the deal version selected in control 948. Deal section 956 may include a tab 958 for inputting and displaying the economics of the selected deal, a tab 976 for inputting and displaying contact information (for example, people and companies associated with the potential lease) for the selected deal, a tab 978 for adding, deleting, and viewing attachments associated with the selected deal, and a tab 980 which accepts general notes about the selected deal.

The illustrated pipeline interface 932 is shown with the economics tab 958 active. The controls 960-974 associated with this tab 958 are used to input and view details about the selected deal. Thus, a control 960 receives the area of the selected deal (typically this will be in square feet, but can also be in other units of area measure such as square yards), a control 962 permits a user to identify the type of lease (for example, new, renew, extend, expire, and so forth), a control 964 receives the start date for the selected deal from a user, a control 966 receives the length of the selected deal from the user, and a control 968 receives the end date of the selected deal from the user. For the date controls 964-968, only two of the three inputs may be entered, and the third may be calculated.

The economics tab 958 also contains a user input control 970 so that a user may select a methodology for expense reimbursement calculations (real estate leases typically contain a form of expense reimbursement in addition to base rent). Also, a user input control 972 permits a user to input additional required information based on the selection made in control 970. A series of controls 974 allows a user to input detailed financial parameters, and view the resulting calculations, for the selected deal.

Referring now to FIG. 29, in addition to a pipeline lease, the system 10 provides for the creation of a forecast lease by using a forecast interface 982 and operated by a market forecast manager or other program component 418. The forecast lease, forecast file, or simply forecast is part of a library 62-74, but are somewhat different than library elements and sub-elements. A forecast includes a collection of library sub-elements, and a few directly entered items. For example, a user may create a forecast for “office floors 10-18.” To do this, he will select a rent sub-element, a tenant improvement sub-element, a leasing commission's sub-element, and so forth. This collection of data is used to forecast future lease cash flows, occupancy, and other metrics, or in other words to generate “forecast leases”. Since forecasts are part of the library, all of the features such as library linking and sensitivities also work for the forecast.

A user may enter and view market forecast data on the forecast interface 982. The market forecast is part of the library, and has features identical to the library sub-elements such as library linking, sensitivity layers, and so forth. It is, however, different in that the forecast is largely a compilation of other library sub-elements, which, when combined, provide sufficient data to generate a hypothetical lease. The example market forecast interface 982 includes a section, control, or menu 984 for a user to add, delete, and select market forecasts, and a section 986 for a user to select library sub-elements, such as rent, to use in the forecast. Section 986 may also be used to enter additional information such as the name of the forecast, the occupancy of the space (office, retail, industrial, mixed-use, for example), and the expected length of leases. A summary area 988 on the forecast interface 982 displays summarized results of the selections and entries made in area 986 including the calculated assumptions and financial data for forecast leases. The forecast interface 982 also has an area 990 where the user can view detailed results of the selections and entries made in area 986.

Once a forecast or forecast lease is formed, it can be selected on the forecast section 264 of the suite/lease interface 228 (FIG. 9) to use the forecast lease in calculations as explained in more detail below.

### IX. Space Continuity and Forecast Shifting

Space continuity is the concept of tracking space in a building over time, as well as the ability to swap potential leases in and out of calculations for a property, and in turn, in and out of a display showing which leases are present in the calculations. The system 10, or alternatively a distinct space continuity system, provides this capability. The space is defined in the section interface 220 (FIG. 8) and generally represents a floor in a building, but can represent other units, such as types of retail space in a mall. Space on the floor is claimed or occupied as stated on the suite/lease interface 228 (FIG. 9). For example, a section (such as a floor of a building for example) can be broken into multiple leases (lease spaces). This allocates first generation space. In addition, future generations of leases can put a claim on a space claimed by prior leases through the space allocation section 244 (FIG. 9). In other words, each lease may claim space from a section, other leases within the section, or a combination of both. During the term of the leases, economic terms and other data are associated with the space. Alternative ways to enter this data exists outside of the lease interface. For instance, the suite/lease interface 228 may be the primary way to gather these inputs, but other options exist such as the pipeline interface.

The space continuity features make it possible to apply filters to include or exclude leases from calculations. The filters to include or exclude certain leases are provided in a reporting interface. The reporting interface may generate reports for printing or exporting, and may permit on-screen reporting that updates in real time. Since space is tracked over time, it is possible to apply filters that include or exclude removable leases based on various parameters. Removable leases are any leases, whether hardcoded, pipeline, or generated by the forecast that occur after a start date entered in the reporting interface. Future leases can be shifted based on which leases are included or excluded. Thus, for example, future leases may be shifted depending on whether an option lease is included or excluded.

As leases are included or excluded, the forecast manager or other program component 418 (FIG. 4) shifts the timing of future (often, but not always generated by the forecast component) leases and their associated calculations. For example, if at least one removable lease, such as an option lease A for example, is filtered out, the system 10 gives users the option to shift leases that were to take place after option lease A expired. The leases may be shifted to a more recent time period to fill the gap in time, and in space, vacated by removing option lease A. In the system 10, lease start and end dates may be variable based on filters that are applied, and this has particular bearing on forecast leasing where the assumptions applied are based on the start date of the forecast lease. This is a great advantage over programs that have leases with fixed start and end dates so that multiple property files are needed to include or exclude a lease for alternative financial calculations.

For the present system, the lease shifting may only need to be performed with one file. Filters can be applied to leave a removable lease in place for example, or alternatively, filters can exclude the removable lease from calculations, in which case other future leases may be moved up in time (and rents, for example, are set based on the lease start date if the rent inputs reference a library sub-element). Either way multiple alternatives are provided for a single property file without the need to duplicate the data in another property file to provide alternative calculations for future leases. Further, a portfolio level reporting interface allows filters to be applied to multiple properties at once, so it is possible, for example, to shift future leases in an entire portfolio based on a filter selection.

The concept of lease shifting is expanded even further when the program is linked to a pipeline application, or when the program directly accepts the input of pipeline data. A pipeline application provides “real-time” data about possible future leases for a space and gathered from leasing agents in the field. This data may be presented at the pipeline interface 932, for example, and incorporated, using the same logic above, into the calculations. This effectively integrates the real time data into projections without the need to manually update the projections. The pipeline interface 932 can also permit a user to toggle the pipeline data on or off based on filters on the pipeline interface 932 so a user can view calculations, for example, where only certain types or statuses of pipeline leases are incorporated. When the pipeline data is enabled, the system 10 is able to gather data from the pipeline application on the current expectations for when and how a space will lease in the future.

The space continuity features may apply to both the forecasting program and the pipeline program independently. So, for example, the pipeline program can accept user inputs for section, suite, and pipeline data, and from these items generate reports and displays. The forecasting program can also function without pipeline data. However, through the API, a property in the pipeline can be linked to a property in a general analysis program. When this occurs, the pipeline data is integrated into the property files within the general analysis program, and the forecast data is integrated into the pipeline.

Referring now to FIG. 30, the logic associated with the space continuity features of the program are illustrated on a reference display such as space continuity chart 992. Thus, if a lease is shown on the chart 992, the lease data for that lease is used in program calculations. The chart 992 has one area or space axis a (extending up and down in the illustrated example) measured in square feet for example, and a time axis b extending transverse to the area axis a and here horizontally for the illustrated example. A title block 998 may identify the section, may provide key data associated with the section, and may have a height indicating the total square feet of the section. In the example, section B has 10,000 SF of lease space.

To enter leases onto the chart 992, a user may enter lease data in the suite/lease interface 228 (FIG. 9) for lease 901 in this example, and used controls 244 on interface 228 to claim 4,000 sf of the total 10,000 sf available from section B. The user would then use the controls 264 (FIG. 9) to designate a forecast for any unclaimed space after the expiration of lease 901.

Similarly, a user entered a lease 903 to claim 3,000 sf of the total 10,000 sf (or of the 6,000 sf still available after suite 901 claimed 4,000 sf) from section B. Again, the user may use controls 264 (FIG. 9) to designate a forecast for any unclaimed space after the expiration of lease 903. The user also entered lease 911 as with leases 901 and 903 except here the user used controls 230 to identify the lease as “non-contractual” and an “option”, and controls 244 to claim 2,000 sf of space from lease 901, and 3,000 sf of space from lease 903. Also, the user here also designated a forecast for any unclaimed space after the expiration of lease 911 as with the other leases.

Finally, the user entered lease 915 after unclaimed space 905, identified the lease as “non-contractual” and an “expansion,” and claimed 1,000 sf of unclaimed space of the 10,000 sf from section B by the controls mentioned above for the other leases. For this lease 915, the user did not enter any data in section 264 (FIG. 9), and therefore forecasts are not used after the expiration of lease 915. These entries result in the illustrated user-inputted leases 901, 903, 911, and 915.

The chart 992 also includes automatically generated forecast leases 907, 909, 913 and others. Forecast lease 907 may be generated based on data entered into the forecast interface 982 (FIG. 29). As mentioned above, the removable option lease 911 claims 2,000 sf of space from lease 901 after lease 901 expires. The forecast is not applied to any space that is claimed, so in the illustrated example, the forecast is only applied to the 2,000 sf that is not claimed, which generates a forecast lease 907. Alternatively, the forecast may also be set to have a minimum duration, such as one year, so that no forecast would fit in the open space directly between the lease 901 and lease 911. The forecast lease repeats along the time axis and based on user entered parameters in the forecast interface 982 (FIG. 29). Thus, after the expiration of the forecast lease 907, the forecast generates a new forecast lease 909, and this pattern repeats perpetually. An open space between adjacent forecast leases may be provided to simulate the time needed to obtain a new tenant.

Forecast lease 913, also calculated based on user inputs in the forecast interface 982 (FIG. 29), claims the entire 5,000 sf from lease 911 since there are no future claims on the space occupied by lease 911. As noted previously, no forecast was designated for lease 915 so no forecast leases are generated.

Item 6108 identifies unclaimed space. Section B consists of 10,000 sf, but only 8,000 sf was claimed by leases. Therefore, there is 2,000 sf unclaimed. This space remains unclaimed until a future lease claims it, and it is also possible that it may never be claimed if it is un-leasable space. In other embodiments, users may be required to claim all space so that unclaimed space does not exist. Financial calculations for the property that includes section B may then be performed by one or more managers based on the leases mentioned above on the chart 992.

Referring to FIG. 31, a chart 994 is shown where at least one future lease, such as the option lease 911, is excluded from calculations, and in turn the chart 994. Chart 994 presents an illustration of the calculations and output if the user uses a filter to remove leases designated as “options” from the calculations. Otherwise, the user-inputted leases 901, 903, 911, 915 in section B remain the same as in chart 992. However, since option lease 911 is now excluded from the calculations, all inputs associated with the option lease 911 are excluded, including its forecast selected in the suite/lease interface 228 (FIG. 9). Since there is no longer a future lease claiming 2,000 sf of lease 901, the forecast designated for lease 901, as specified through section 264 of the suite/lease interface 228 (FIG. 9), takes over and generates forecast lease 917, and subsequent leases to fill the gap in time and space formed by removing the option lease 911. The exclusion of lease 911 also results in no future claims on space after lease 903 expires. Therefore, the forecast designated through section 264 of the suite/lease interface 228 (FIG. 9) takes over and generates forecast lease 919 and subsequent leases.

Referring to FIG. 32, a chart 996 presents an illustration of the calculations and output if the user were to remove the filter restricting “option” leases, and the user also enabled the incorporation of pipeline data, which, for example, may be entered through the pipeline interface 932 (FIG. 28). When the pipeline data is directly integrated into the calculations, data filters are applied to determine which leases to include in calculations. Filters can include date ranges, status selections, or nearly any other variable. In the illustrated example, leases 901 and 903 are contractual, so if contractual leases are treated as “prior leases” for pipeline purposes, data from these leases would be used to populate fields 936-946 in the example pipeline interface 932 (FIG. 28). If non-contractual leases are defined as the budget (expected parameters for future leases), then data from leases 911, 915, as well as data from forecast leases 907 and 913 are used to populate budget data as illustrated in the example pipeline interface 932 (FIG. 28), which may be accessible through the program, or through an external pipeline application.

In chart 996, if a user of the pipeline interface 932 entered pipeline lease 921, and the user of a reporting interface (which may be the same user) applies filters that allow the pipeline lease 921 to be incorporated into calculations, then the pipeline lease 921 is included in the calculations as a claim on space after lease 901 expires. The forecast associated with lease 901 is also shifted, and does not take over until after pipeline lease 921 expires, at which point a forecast lease 923 is generated based on data entered in the forecast interface 982 (FIG. 29).

A pipeline lease 925 is also added to chart 996 for inclusion in the calculations. This pipeline lease 925 places a claim on 2,000 sf of the area previously occupied by lease 911. This shifts the use of the forecast for 2,000 sf until after the expiration of pipeline lease 925, at which point, the forecast generates a forecast lease 929. The remaining 3,000 sf of space associated with space 911 remains unclaimed, so the forecast designated as part of lease 911 takes over and generates forecast lease 927.

It will be appreciated that section data plus any combination of one or more of suite/lease data, pipeline data, and forecast data are sufficient to generate adequate data for the chart interfaces 992, 994, 996 to work (though freestanding forecast data requires a modified, very simple, element of suite/lease data to assign it to sections).

It will also be appreciated that the possible combinations of data based on data types (suite/lease, pipeline, forecast) and filters are not limited to these types, other types, or all types, of leases or data may be removable, and the charts may be operative for many other different data types. The illustrated charts only provide a few examples.

The calculations represented by the charts 992, 994, 996 combine many of the aspects of the system 10 including (1) workgroups/library links/sensitivities, and (2) the space continuity logic. For example, the shared library and sensitivity features drive the economics of the leases (as well as the amount of time space is vacant between leases), so the rents calculated and many other economic parameters may be a function of the selected library, and the active sensitivity. Thus, if a user linked the property to a library, values from that library would then drive the forecast, as well as some of the suite/lease calculations, valuation, and so forth (to the extent inputs are linked to the library rather than hardcoded). If the user then created multiple sensitivities, those sensitivities could then be applied to change the forecast and other values. The results of these changes flow through the calculations and can both change the shape of the boxes (as a result of forecast lease lengths and vacancy between leases), as well as change values displayed in the boxes such as rents.

Referring to FIG. 33, a chart 951 may be displayed on a user interface for a user to view and/or interact with sections of a property over time and based on the logic already presented by charts 992, 994, 996 (FIGS. 30-32). The same Section B from chart 992 (FIG. 30) is part of chart 951 and has the same components indicated on chart 992. Each lease that occupies space within a section 953, 957 is illustrated as a box 963, although any other indicia may be used such as other shapes, symbols, or text instead of boxes to name a few examples. Here also, one axis 957 represents time, and a transverse axis s represents area or space. Typical increments along the time axis 957 may be in months, or any other user designated unit. Other rows may be provided along the time axis 957 such as a row 959 to illustrate other key data points associated with the time periods such as occupancy of the building for the identified time period as one example.

The chart 951 has two sections 953 and 957 which may represent two different floors of a building, two different areas on the same floor, or any other division of property as defined in the section interface 220 (FIG. 8). All items in this illustration can be clicked on to reveal more data. For example, a user may click on a section title block 961 to view and edit details of the section, click on a lease to view and edit lease details, or click on a forecast lease to view and edit details of the forecast. Further, the user may designate which metrics to show in the lease boxes 963. In one form, the lease boxes 963 display additional information about the lease, such as rents, tenant names, and so forth viewable on the chart 951.

It will be appreciated by those skilled in the art that modifications to the foregoing embodiments may be made in various aspects. Other variations clearly would also work, and are within the scope and spirit of the invention. The present invention is set forth with particularity in the appended claims. It is deemed that the spirit and scope of that invention encompasses such modifications and alterations to the embodiments herein as would be apparent to one of ordinary skill in the art and familiar with the teachings of the present application.

1. A system for analyzing property data, comprising:
at least one library having at least one set of assumptions of property data and stored on a data storage device, the at least one library being configured to accept links from one or more property files, each property file having data identifying a property;
wherein each property file is linked to, at most, one library at a time; and
wherein, if multiple libraries are present, the system is configured to permit relinking a property file from a first library to a second library;
and
a system component configured to permit the at least one set of assumptions to be selected for use with a plurality of the property files linked to the at least one library;
wherein the system is configured to access the at least one set of assumptions and generate calculations based at least in part on the at least one set of assumptions to analyze current or expected performance of at least one property identified by the plurality of property files linked to the at least one library.

2. The system of claim 1, comprising a property file interface for a user to input an input set of assumptions into the at least one library, and the same or another system component configured to make the input set of assumptions available to use with a plurality of the other property files linked to the at least one library.

3. The system of claim 1, comprising a system component configured to input a stored set of assumptions stored in a memory and into the at least one library, and the same or another system component to make the stored set of assumptions available to use with a plurality of the other property files linked to the at least one library.

4. The system of claim 1, comprising a system component configured to input an external set of assumptions imported from an external source and into the at least one library, and the same or another system component to make the external set of assumptions available to use with a plurality of the other property files linked to the at least one library.

5. The system of claim 1, comprising a system component configured to export a set of assumptions to an external source for aggregation into market data available to other users.

6. The system of claim h wherein a library includes a baseline layer having a set of assumptions and at least one sensitivity layer each with a set of assumptions, wherein the set of assumptions of the at least one sensitivity layer has at least one different assumption from an assumption on any other layer within the library; and
wherein the system is configured to permit a linked property file to be used with at least one selected layer within the library.

7. The system of claim 6, wherein each layer has at least one assumption different from that in all other layers within the same library.

8. The system of claim 6, further comprising a system component to generate a display for a user interface and indicate differences between at least two of the layers on the display.

9. The system of claim 6, further comprising a system component to generate a report of inputs or outputs or both associated with at least one layer.

10. The system of claim 6, wherein the layers are configured to be modified by a user to form a modified layer that may be used with a plurality of the property files linked to one of the libraries.

11. The system of claim 6, wherein a library is accessible by a plurality of authorized users, the system further comprising a system component configured to authorize a selected user of the plurality of authorized users for editing one or more layers at the library.

12. The system of claim 1, wherein each property file represents real property.

13. The system of claim 1, wherein each library is updated with the same new data as each of the other libraries.

14. The system of claim h further comprising:
a workgroup of users authorized to use the at least one set of assumptions at a library; and
a workgroup component providing workgroup administrator privileges to control membership in the workgroup.

15. The system of claim 14, wherein a plurality of the property files linked to a library are accessible to the users in the workgroup.

16. The system of claim 14, wherein all of the property files linked to a library are accessible to the users in the workgroup.

17. The system of claim 14, further comprising a system component for providing an interface for users of a workgroup to share portfolios of property files to maintain a corresponding organization of the property files for two or more users in the workgroup.

18. The system of claim 14, wherein one layer of a plurality of layers in a library is a baseline layer having a set of assumptions, the system further comprising at least one sensitivity layer each with a set of assumptions, each layer having at least one assumption different from the assumptions in any other layer within the same library,
wherein the system component or another system component is configured to permit a property file linked to the library and accessible to the workgroup to be used with at least one selected layer within the library, and
wherein the system component or another system component permit the users in the workgroup access to one or more of the layers at the library.

19. The system of claim 1, wherein the property files are selectively linked and unlinked from a library.

20. The system of claim 1, wherein each property file identifies a different property or different versions of the same property.

21. The system of claim 1, wherein the assumptions are values of at least one of:
growth rates,
rent value,
current rent value,
high rent value,
low rent value,
free rent periods provided to a tenant,
leasing commission paid for obtaining tenants,
landlord work,
tenant improvement,
rent step that indicates a change in rent value between lease time periods,
rental growth factor that indicates a change in rent value,
market forecast that includes a set of assumptions adequate to calculate a future lease,
porter's wage curve,
loan terms,
transaction expenses,
valuation metrics,
payment schedule, and
probability that a lease will be renewed at expiration.

22. The system of claim 1, comprising a system component permitting an external pipeline program to access property data at the system.

23. A system for analyzing property data, comprising:
a library having sets of assumptions of property data stored on a data storage device, the library being configured to accept links from one or more property files identifying a property, wherein assumptions are values entered within the library for the property data;
the library data comprising:
a baseline layer comprising a set of assumptions of property data, and
at least one sensitivity layer comprising a set of assumptions of property data with at least one of the assumptions different from an assumption on any other layer within the same library; and
a system component generating a user interface permitting a user to select at least one of the layers for use with a property file linked to the library in a financial calculation;
wherein the system is configured to use assumptions in the selected layer or layers in generating calculations to analyze current or expected performance of the one or more properties identified by the one or more property files linked to the library.

24. The system of claim 23, wherein the library is configured to accept links from a plurality of property files, each linked property file being usable with at least one selected layer.

25. The system of claim 23, further comprising a system component permitting an external pipeline program to access property data at the system.

26. The system of claim 23, further comprising the same or another system component for generating a display for a user interface and indicating differences between at least two of the layers on the display.

27. The system of claim 23, further comprising the same or another system component for generating a report of inputs or outputs or both associated with at least one layer.

28. The system of claim 23, wherein the layers are modifiable to form a modified layer, and wherein a library that has the modified layer permits the modified layer to be selectively used with a plurality of the property files linked to the library.

29. The system of claim 23, wherein the at least one library is configured to be accessible by a plurality of authorized users, and wherein the system component or another system component is configured to authorize a selected user of the plurality of users to edit at least one layer at the at least one library.

30-40. (canceled)

41. A method for analyzing property data, comprising:
linking a plurality of property files to at least one library on a data storage device, each property file having data identifying a property, wherein each property file is not part of the at least one library,
receiving at least one set of assumptions of property data for storage at the at least one library,
permitting the at least one set of assumptions to be selected for use with a plurality of the property files linked to the at least one library,
accessing, by a computer, the linked property files and at least one assumption of the at least one set of assumptions, and
applying, by the computer, the accessed at least one assumption to one or more of the linked property files,
wherein the applying step includes generating calculations to analyze current or expected performance of one or more properties identified by the property files linked to the at least one library.

42. The method of claim 41, further comprising:
providing a property file interface for a user to input an input set of assumptions into the at least one library; and
making the input set of assumptions available to use with a plurality of the other property files linked to the at least one library.

43. The method of claim 41, further comprising:
inputting a stored set of assumptions stored in a memory and into the library; and
making the stored set of assumptions available to use with a plurality of the other property files linked to the library.

44. The method of claim 41, further comprising:
inputting an external set of assumptions imported from an external source and into the library; and
making the external set of assumptions available to use with a plurality of the other property files linked to the library.

45. The method of claim 41, further comprising
forming a plurality of layers within one library of the at least one library, the forming step comprising:
forming one base set of assumptions of the at least one set of assumptions as a baseline layer; and
forming at least one sensitivity layer at the one library by copying the base set of assumptions from the baseline layer and changing at least one assumption; the method further comprising:
permitting a property file linked to the one library to be used with at least one layer of the plurality of layers within the one library.

46. The method of claim 45, further comprising forming a plurality of sensitivity layers wherein each sensitivity layer has an assumption different from any other sensitivity layer within the same one library.

47. The method of claim 45, further comprising indicating differences between at least two of the layers on a display viewable by a user.

48. The method of claim 45, further comprising generating a report of inputs or outputs or both associated with at least one layer.

49. The method of claim 45, further comprising:
permitting modification of at least one of the layers at the one library; and
permitting a plurality of the property files linked to the one library to be used with the at least one modified layer.

50. The method of claim 45, further comprising:
permitting access to the one library by a plurality of authorized users; and
authorizing a selected user of the plurality of users to edit one or more layers at the at least one library.

51. The method of claim 41, wherein each property file represents real property.

52. The method of claim 41, further comprising automatically updating a plurality of libraries with new data, wherein the same new data is added to each library.

53. The method of claim 41, further comprising:
forming a workgroup of users authorized to use the at least one set of assumptions at a library; and
controlling membership of the workgroup.

54. The method of claim 53, further comprising providing access to a plurality of the property files linked to the library to the workgroup of users.

55. The method of claim 53, comprising providing an interface for the workgroup of users to share portfolios of property files to maintain a corresponding organization of the property files for two or more users in the workgroup.

56. The method of system of claim 53, further comprising:
forming the at least one set of assumptions as a baseline layer;
forming at least one sensitivity layer each with a set of assumptions, each layer having at least one assumption different from the assumptions in other layers within the same library, and
permitting a linked property file accessible to the workgroup to be used with a plurality of the layers within the library.

57. The method of claim 41, wherein the property files are selectively linked or unlinked from the libraries.

58. The method of claim 41, wherein each property file identifies a different property or a different version of the same property.

59. The method of claim 41, wherein the assumptions are values of at least one of:
growth rates,
rent value
current rent value,
high rent value,
low rent value,
free rent periods provided to a tenant,
leasing commission paid for obtaining tenants,
landlord work,
tenant improvement,
rent step that indicates a change in rent value between lease time periods,
rental growth factor that indicates a change in rent value,
market forecast that includes a set of assumptions adequate to calculate a future lease,
porter's wage curve,
loan terms,
transaction expenses,
valuation metrics,
payment schedule, and
probability that a lease will be renewed at expiration.

60. The method of claim 41, further comprising permitting an external pipeline program to access the property data.

61. A method for analyzing property data, comprising:
linking, by a computer, a property file having data identifying a property to a library stored on a data storage device;
forming, in the library, a baseline layer comprising a set of assumptions of property data;
forming, in the library, at least one sensitivity layer comprising a set of assumptions of property data; wherein assumptions are values entered for the property data and wherein the set of assumptions of the at least one sensitivity layer has at least one different assumption from an assumption on any other layer within the library;
receiving a selection of at least one of the layers for use with the property file in a calculation; and
generating, by a computer, calculations using at least the assumptions in the selected at least one of the layers to analyze current or expected performance of the property identified by the property file linked to the library.

62. The method of claim 61, further comprising accepting links from a plurality of property files and to the library, each linked property file being usable with one or more selected layers.

63. The method of claim 61, further comprising permitting an external pipeline program to access the property data.

64. The method of claim 61, further comprising generating a display for a user interface and indicating differences between at least two of the layers on the display.

65. The method of claim 61, further comprising generating a report of inputs or outputs or both associated with at least one layer.

66. The method of claim 61, further comprising:
permitting a user to modify a layer; and
permitting use of the modified layer with a plurality of the property files linked to the library.

67. The method of claim 61, comprising:
permitting a plurality of authorized users to access the library; and
authorizing a selected user of the plurality of users to edit at least one layer at the at least one library.

68-81. (canceled)
